(19) United States
(12) Patent Application Publication
(10) Pub. No.: US 2017/0087473 A1
(43) Pub. Date: Mar. 30, 2017

(54) VIRTUAL ENVIRONMENTS FOR MANAGING AND INTERACTING WITH VIRTUAL SPORTS LEAGUES

(71) Applicant: SportsWorld, Inc., Seattle, WA (US)

(72) Inventors: Howard L. SIEGEL, River Vale, NJ (US); Warren Scott SPIVAK, Scottsdale, AZ (US)

(21) Appl. No.: 15/280,209

(22) Filed: Sep. 29, 2016

Related U.S. Application Data
(60) Provisional application No. 62/234,250, filed on Sep. 29, 2015.

(51) Int. Cl. A63F 13/828; G07F 17/32; G07F 17/34; H04L 29/06

(52) U.S. Cl. CPC A63F 13/828; H04L 67/38; G07F 17/3258; G07F 17/34; G07F 17/3293; G07F 17/3225; A63F 2300/8052

(57) ABSTRACT

One or more embodiments provide a virtual environment that enables users to have their own personalized avatars (including the use of representations of users' own faces). In this virtual environment, users can play a virtual sports game where the drafting of the players for the particular virtual sport being played is conducted by a virtual game such as poker, blackjack and other games. A dealer in a virtual environment can deal out “cards” that show the names of the sports players, their teams and up-to-date statistics for each athlete in the particular virtual sport being played to the personalized avatars of players sitting around a virtual casino table. Winners of a virtual sports game are determined based on aggregated historical statistics compiled by the athletes in the user's final hand for a given historical period of time that has occurred prior to conducting the draft in comparison to aggregated historical statistics compiled for athletes in the final hand of the other users for the same given historical period of time.

### CROSS-REFERENCE TO RELATED APPLICATIONS

This application is based upon and claims priority to U.S. Provisional Patent Application Ser. No. 62/234,250, filed Sep. 29, 2015, the disclosure of which is hereby incorporated by reference in its entirety.

### BACKGROUND

The present disclosure generally relates to virtual environments, and more particularly relates to virtual environments for virtual sport leagues.

Virtual sport leagues (also referred to as fantasy sport leagues) have become increasingly popular over the years. These virtual leagues allow individuals to act as owners or general managers of a simulated/virtual sports team. Each simulated sporting team is comprised of players that are based on human players from real-life sporting teams. In most virtual leagues, teams participate against each other based on a point system. Points are generally awarded to a virtual team based on the game performance of a simulated player's real-life counterpart. The virtual team with the most points at the end of a season (or, in the case of “daily” games, at the end of each day or week) is usually designated the winner.

### BRIEF SUMMARY

In one embodiment, a method with an information processing system, for managing a virtual sports league interactive environment is disclosed. The method comprises generating at least one virtual representation of a user for a virtual sports league interactive environment. The virtual representation comprises at least one real facial feature of the user. At least one user drafting room is generated in the virtual sports league interactive environment. The user drafting room is personalized by the user and comprises one or more virtual representations of sponsored products. In one embodiment, there are separate rooms based on users' preferences for sports teams. For example, there can be a separate Seattle Seahawks room and a separate New York Mets room.

In another embodiment, users participate in a virtual sports game where the drafting of the players for the particular virtual sport being played is conducted by playing poker, blackjack and other games. A dealer in a virtual environment can deal out “cards” that show the names of the sports players, their teams and up-to-date statistics for each athlete in the particular virtual sport being played to the personalized avatars of players sitting around a virtual casino table. Alternatively, the users can receive their cards by pulling a virtual lever of a virtual slot machine. There can be virtual cocktail waitresses that come by that serve the users virtual drinks. These waitresses and drinks can be sponsored. Winners of these games would be determined based on the aggregated statistics compiled by the athletes in the user's final hand of cards for that day (in the case of daily games) or week (in the case of weekly games) in comparison to the aggregated statistics of the players compiled for the other users. There are several alternative methods for determining total points. Users can have the ability to make bets with virtual or actual currency to determine the “pot” of currency that can be won for each game. In another embodiment, there can be a ranking system for the users based on points accumulated, games played and win-loss record. Tournaments can be conducted involving a specified number of users based on these rankings. Prizes can be awarded for winners.

In yet another embodiment, personalized avatars in a virtual environment play various “survivor” games where if a user makes an incorrect choice at any point in time the user is eliminated and the last user to not be eliminated wins the game. In addition, if a user orders a specified amount of retail goods from one or more specified retailers, the user can get an advantage in the game or get an additional life in the game. This retail element presents a novel method for gaming companies to monetize their games because, unlike conventional methods of requiring users to expend real or virtual currency to gain advantages or stay alive in games, this disclosure would provide users with goods in addition to gaining advantages or staying alive in games. There can be prizes awarded to users from sponsors for the last survivor in each game.

In a further embodiment, users participate in all of the foregoing virtual sports games where the data attributed to each user's team of real-world athletes is based on historical statistics. This allows the outcome of virtual sports games to be determined immediately after each user completes the drafting of real-world athletes. Therefore, this allows users to play virtual sports leagues with win/loss results 24 hours a day, 7 days a week, including during a sport's “offseason” (for example, baseball virtual league games can be played during the winter, and football virtual league games can be played during the spring).

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a block diagram illustrating a detailed view of a virtual environment manager according to one embodiment of the present disclosure;

FIG. 3 shows one example of a user profile according to one embodiment of the present disclosure;

FIG. 4 shows one example of an avatar profile according to one embodiment of the present disclosure;

FIG. 5 shows one example of a common room in a virtual environment according to one embodiment of the present disclosure;

FIG. 6 shows one example of a sponsor profile according to one embodiment of the present disclosure;

FIG. 7 shows one example of a fan room profile according to one embodiment of the present disclosure;

FIG. 8 shows one example of a fan room for a particular sports team according to one embodiment of the present disclosure;

FIG. 9 shows one example of a user room profile according to one embodiment of the present disclosure;

FIG. 10 shows one example of a user room according to one embodiment of the present disclosure;

FIG. 11 shows one example of a game room profile according to one embodiment of the present disclosure;

FIG. 12 shows one example of a game profile according to one embodiment of the present disclosure;

FIG. 13 shows one example of a game room within a virtual environment where virtual games are played by users for drafting athletes for their virtual sports teams according to one embodiment of the present disclosure;

FIG. 14 shows various examples of player profiles according to one embodiment of the present disclosure;

FIG. 15 shows various examples of a team profiles according to one embodiment of the present disclosure;

FIG. 16 shows one example of a common area of a virtual environment for a survivor pool game according to one embodiment of the present disclosure;

FIG. 17 is an operational flow diagram illustrating one example of a process for populating a virtual environment with an avatar associated with a user according to one embodiment of the present disclosure;

FIG. 18 is an operational flow diagram illustrating one example of a process for generating and managing a virtual sports game where a virtual sports team draft is conducted by presenting a poker game to users with cards having the names of athletes in a virtual environment according to one embodiment of the present disclosure;

FIG. 19 is an operational flow diagram illustrating one example of a process for generating and managing a virtual sports game where input is received from users to place cards with names of athletes in order from the card that the user predicts will generate the lowest point total to the card that the user predicts will generate the highest point total in a virtual environment according to one embodiment of the present disclosure;

FIG. 20 is an operational flow diagram illustrating one example of a process for generating and managing a virtual sports game where input is received from a user designating a card with a name of an athlete as a low card (i.e., the card that the user predicts will generate the lowest point total) and designating a card with a name of an athlete as a high card (i.e., the card that the user predicts will generate the highest point total) in a virtual environment according to one embodiment of the present disclosure;

FIG. 21 is an operational flow diagram illustrating one example of a process for generating and managing a virtual sports game where points are given to a user based on the performance of real-life athletes associated with a user's cards, where a user wins or loses the game based on his/her point total as compared to a virtual dealer's point total in a virtual environment according to one embodiment of the present disclosure;

FIG. 22 is an operational flow diagram illustrating one example of a process for generating and managing a virtual sports survivor pool game in a virtual environment according to one embodiment of the present disclosure; and

FIG. 23 is a block diagram illustrating one example of an information processing system according to one embodiment of the present disclosure.

### DETAILED DESCRIPTION

One or more embodiments provide various mechanisms for conducting virtual sports drafts by playing games (such as card games, casino games and other games). Other embodiments realize new virtual sports games and survivor pools (as discussed below) involving card games, casino games and other novel games. Further embodiments utilize retail transactions as a way to influence the outcome of online and mobile games and applications generally and online and mobile virtual sports games and applications in particular. Additional embodiments provide various mechanisms for conducting virtual sports drafting by playing games (such as card games, casino games and other games) by having the data attributed to each user's team of players based on historical statistics.

Although there are several different types of virtual sports games, the selection of players for a virtual sports team is generally limited to (a) a traditional draft where users make selections in a pre-determined order and (b) a salary cap draft where each user has a specified aggregate dollar amount to spend on players that each has assigned dollar amounts. Various embodiments of the present disclosure, on the other hand, provide new and novel mechanisms for users to draft/select players for virtual sports teams by various virtual games, including poker, blackjack and other card and casino games. One or more embodiments further present the concept of utilizing retail transactions such as a user's purchase of a specified amount of goods from one or more specified retailers as a way to improve the user's chances of winning the virtual sports games (or any other online or mobile game or application) and to provide the user with the ability to have one or more additional “lives” in a game or application if the user purchases a specified amount of goods from one or more specified retailers.

In addition, most virtual sports league games are determined based on the future performances of the real-world athletes on each user's team. However, one or more embodiments create and manage virtual sports games where the underlying data attributable to each user's team of real-world athletes is based on historical statistics, thereby providing virtual sports games where the winners can be determined immediately after the draft of a user's team of real-world athletes rather than waiting for the outcome of future results.

### Operating Environment

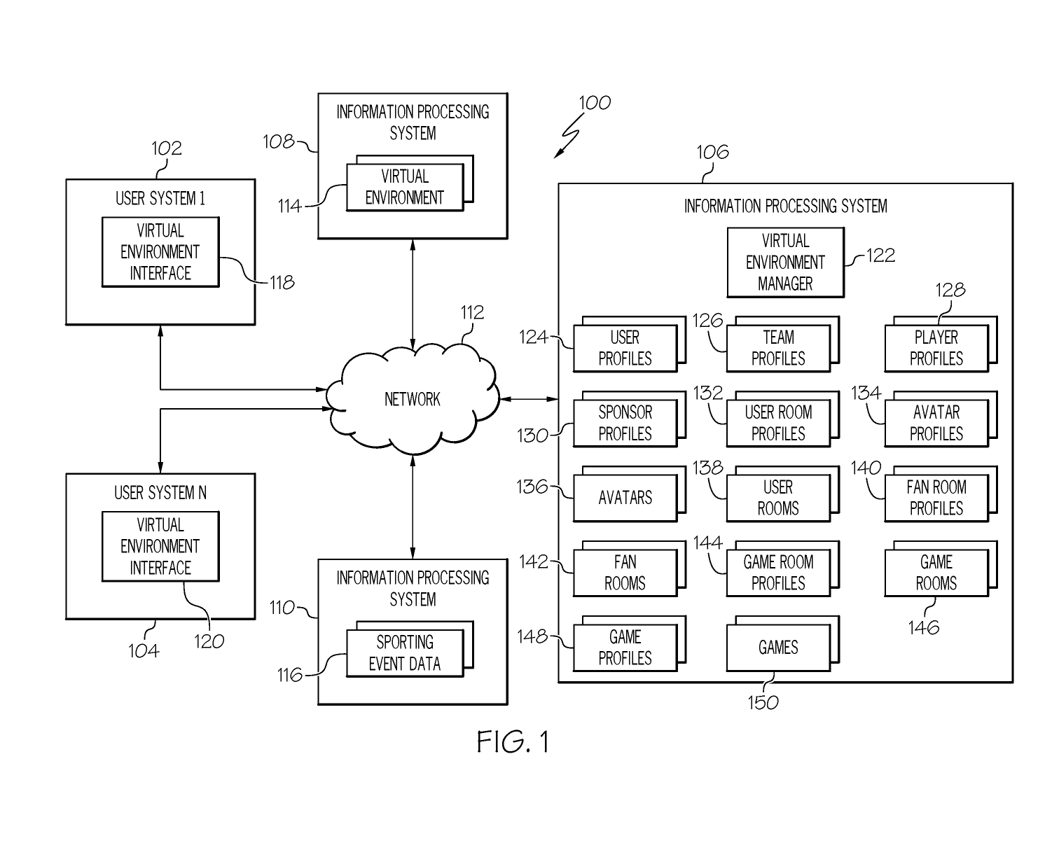

FIG. 1 shows one example of an operating environment 100 for managing a virtual environment(s) comprising one or more simulated sport leagues. In particular, FIG. 1 shows a plurality of user systems 102, 104 and server systems 106, 108, 110 communicatively coupled to at least one network 112. The network 112, in one embodiment, comprises a wide area network, a local area network, a wireless network, a telecommunications network, and/or the like. A user system 102, 104 can include, for example, information processing systems such as desktop computers; portable computing devices such as laptop computers, mobile/smart phones, tablets, wearable computing devices (e.g., smart watches, bands, etc.), personal digital assistants, etc.; and/or the like. The server systems 106, 108, 110 comprise information processing systems that manage access to one or more centralized resources and/or services.

In one embodiment, at least one server system 108 comprises one or more virtual environments (VEM) 114. In this embodiment, a virtual environment 114 comprises a virtual/simulated sports league in which users compete against each other. One example of a virtual/simulated sports league is a virtual sports league. The virtual environment 114 provides an interactive environment where users create virtual teams composed of virtual representations of real-life players. A user acts as the owner or general manager of his/her virtual team. For example, a user creates his/her team by “drafting” virtual representations of real-life players.

Virtual teams compete against each other based on real-life sporting event data 116 such as (but not limited to) statistics and other metrics associated with each virtual player's real-life counterpart. For example, if Virtual_Team_A comprises Virtual_Player_A representing Real-Life_Player_A, Virtual_Player_A is awarded points (or any other type of award mechanism) based on the performance (and other metrics) of Real-Life_Player_A in a real-life game. In this embodiment, a season of a virtual sports league corresponds to the season of the real-life sporting league. In so-called “daily” virtual sports leagues, the so-called “season” is comprised of one (or more) day(s) of the real-life sporting event. Points can be awarded to a virtual team and its players at different granularities such as on a game-by-game basis, weekly basis, monthly basis, and/or the like. The virtual teams and their players are ranked according to their point totals. Rankings can be determined at different granularities as well. For example, rankings can be determined on a game-by-game basis, weekly basis, monthly basis, and/or the like. In one embodiment, the virtual team with the most points at the end of the season is determined to be the league champion. However, other mechanisms for determining a league champion are applicable as well. It should be noted that the sporting event data 116 can include real-time data; data for the current real-life season; historical data for previous seasons, years, days, games, and/or the like; etc.

Each of the user systems 102, 104 comprises one or more virtual environment interfaces 118, 120. The virtual environment interfaces 118, 120 allow the user systems 118, 120 to communicate with the virtual environment 114. The interfaces 118, 120 also allow a user associated with each user system 102, 104 to interact with the virtual environment 114. In one embodiment, the virtual environment 114 is a tool such as an application(s), an application programming interface, a website, a web application, a mashup, and/or the like.

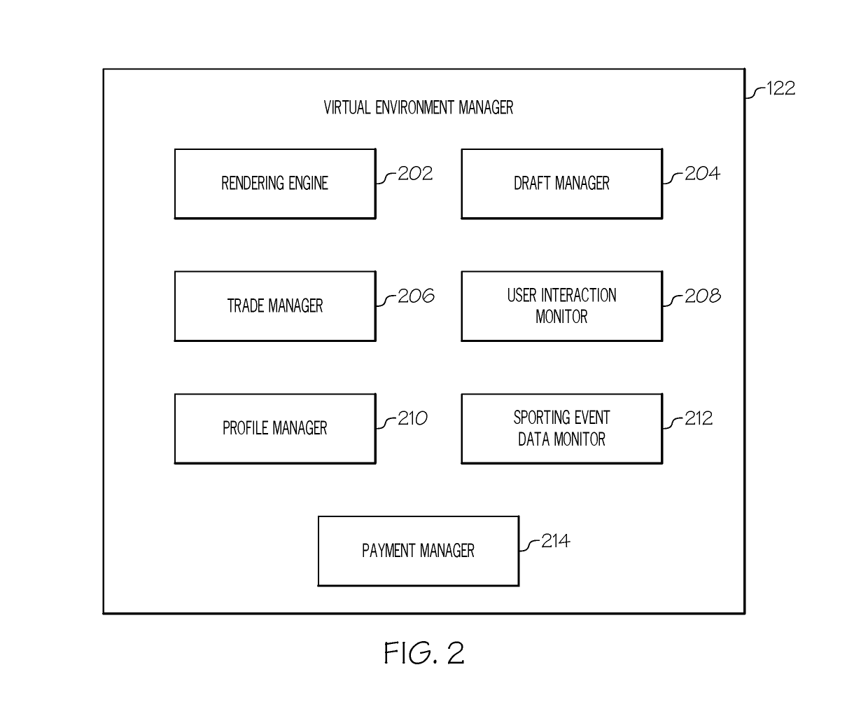

FIG. 1 further shows that at least one of the server systems 106 comprises a virtual environment manager 122, user profiles 124, team profiles 126, player profiles 128, sponsor/advertiser profiles 130, user room profiles 132, avatar profiles 134, avatars 136, user rooms 138, fan room (e.g., rooms for fans of particular sports teams) profiles 140, fan rooms 142, game room profiles 144, game rooms 146, virtual game profiles 148, and virtual games 150. Each of these components is discussed in greater detail below. The virtual environment manager 122 provides and manages the virtual environment 122. The virtual environment manager 122 comprises a rendering engine 202 (FIG. 2), a draft manager 204, a game manager 206 configured to manage the game(s) being played by the user, such as poker, used to conduct a player draft), a user interaction manager 208, a profile manager 210, a sporting event data monitor 212, and a payment manager 214. Each of these components is discussed in greater detail below. It should be noted that, in at least some embodiments, the virtual environment manager 122 or at least one of its components is distributed across one or more information processing systems. It should also be noted that the virtual environment manager 122 can be situated on the same system 108 as the virtual environment 114, and/or can be part of the virtual environment 114.

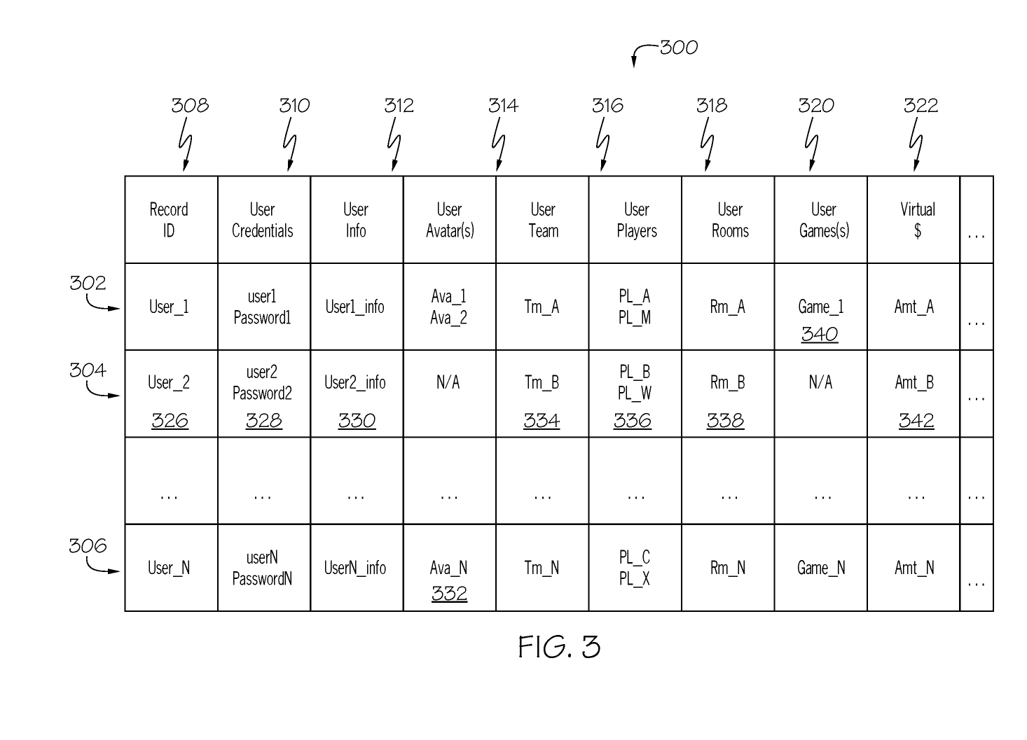

As discussed above, users interact with the virtual environment 114 via the interface 118 disposed on their system(s) 102, 104. In one embodiment, users first register with the virtual environment 114. The profile manager 210 of the virtual environment manger 122 creates a user profile record 302, 304, 306 for a given user based on a registration request and information provided by the user. FIG. 3 shows various examples of user profiles. In the example shown in FIG. 3, each row 302, 304, 306 in the table 300 corresponds to a user profile. It should be noted that in other embodiments, each user profile 302, 304, 306 is stored separate from one another. The table 300 comprises a plurality of columns, each storing a different set of information. In this example, the table 300 comprises a first column 308 entitled “Record ID”; a second column 310 entitled “User Credentials”; a third column 312 entitled “User Info”; a fourth column 314 entitled “User Avatar(s)”; a fifth column 316 entitled “User Team”; a sixth column 318 entitled “User Players”; a seventh column 320 entitled “User Rooms”; and an eighth column 322 entitled “User Game(s)”, and a ninth column entitled “Virtual $” 324.

The “Record ID” column 308 comprises entries 326 uniquely identifying each user profile in the table 300. The “User Credentials” column 310 comprises entries 328 with user login credentials for the virtual environment 114. Examples of user login credentials include (but are not limited to) a unique username and a password. The “User Info” 312 column comprises entries 330 including user information such as (but not limited to) user registration information. User registration information includes, for example, the user's name, address, phone number, email address, birthdate, payment information, and/or the like. The “User Avatar(s)” column 314 comprises entries 332 with a pointer to a record in the avatar profiles 134 associated with the user identified by the user profile.

The “User Team” column 316 comprises entries 334 with a pointer to a record in the user team profiles 126 associated with the user identified by the user profile. The “User Players” column 318 comprises entries 336 with a pointer to a record in the player profiles 128 associated with the user identified by the user profile. The “User Rooms” column 320 comprises entries 338 with a pointer to a record in the user rooms profiles 132 associated with the user identified by the user profile.

The “User Game(s)” column 322 comprises entries 340 identifying a virtual game currently being played by the user and/or virtual games previously played by the user in the virtual environment 114. Examples of virtual games include a virtual poker game, a virtual slot machine, and/or the like. Users interact with these virtual games in order to draft the players for their virtual sporting teams. Another example of a virtual game is a survivor pool game where different users select a different real-world team to win their respective game on a given day, in a given week, etc. Users who select a winning team advance to the next round, while users who select a losing team are eliminated. The last user remaining after the final round of the game is declared the winner. The “Virtual $” column 322 comprises entries 338 identifying a current amount of virtual currency available to the user identified by the user profile.

After a user has registered with the virtual environment 114, the user is able to login into and interact with the environment 114. For example, the user initiates his/her virtual environment interface 118, which communicates with the virtual environment manager 122. In this embodiment, the rendering engine 202 of the manager 114 presents a login section of the environment 114 to the user via the interface 118. The user is able to enter his/her login credentials (or create an account for the virtual environment 114). After the user enters his/her login credentials (e.g., username and password), the user interaction monitor 208 of the environment manager 122 verifies the user's credentials based on the user's profile 124. For example, the user interaction monitor 208 compares the username and password entered by the user with the username and password information in the user's profile 124. If a match occurs, the user interaction monitor 208 grants access to the virtual environment 114. If a match does not occur, the user is denied access to the user interaction monitor 208.

Once the user has logged in, the rendering engine 202 presents the user with an option for selecting a default virtual representation (avatar) or a personalized virtual representation (avatar) of the user for the environment 114. If the user selects a default avatar, the rendering engine 202 randomly selects (or generates) a default avatar from a plurality of avatars 136. It should be noted that, in one embodiment, a default avatar is selected with a gender corresponding to the gender of the user, as provided by the user's profile 128. It should be noted that in another embodiment, the rendering engine 202 presents the user with a list of default (non-personalized) avatars for selection by the user. The user selects one of these displayed default avatars via the interface 118. The user can also indicate if he/she wants this selected avatar to be the user's default avatar. If so, the user's profile 124 is updated to include a pointer to the record in the avatar profiles 134 associated with the selected avatar. In this embodiment, when a user subsequently logs in to the virtual environment 114 the rendering engine 202 automatically selects and displays this default avatar.

If the user selects the personalized avatar option, the user interaction monitor 208 receives this selection and determines if the user has previously created a personalized avatar. For example, the user interaction monitor 208 analyzes the user profile 124 associated with the user, and identifies the “User Avatar(s)” entry. The user interaction monitor 208 determines if this entry identifies an avatar record associated with a personalized avatar. If so, the user interaction monitor 208 queries the user to determine if he/she would like to use this personalized avatar or create a new one. If the user indicates that he/she wants to use the identified personalized avatar, the rendering engine 202 selects and renders this avatar as the user/s virtual representation within the virtual environment 114.

If the user indicates that he/she wants to create a new avatar or is not currently associated with a personalized avatar, the rendering engine 202 presents one or more portions of the virtual environment 114, via the interface 118, which allow the user to create a personalized avatar. In one embodiment, the user is able to create an avatar that substantially resembles and comprises similar physical features to the user. In this embodiment, a user can submit a photograph of himself/herself to the virtual environment manager 122. The rendering engine 202 analyzes the photograph for various physical features of the user including (but not limited to) gender, height, weight, hair color, eye color, skin color, eye shape, jaw shape, distance between eyes, and/or the like. The rendering engine 202 then creates an avatar comprising these physical features of the user. In another embodiment, the user is presented with a tool that allows the user to manually select multiple physical features for an avatar. The rendering engine 202 generates an avatar based on the physical features selected by the user. In addition to physical features, users are able to select the type of clothing and accessories worn by an avatar. For example, users can select from various uniforms, sporting equipment, and non-sports related clothing/accessories.

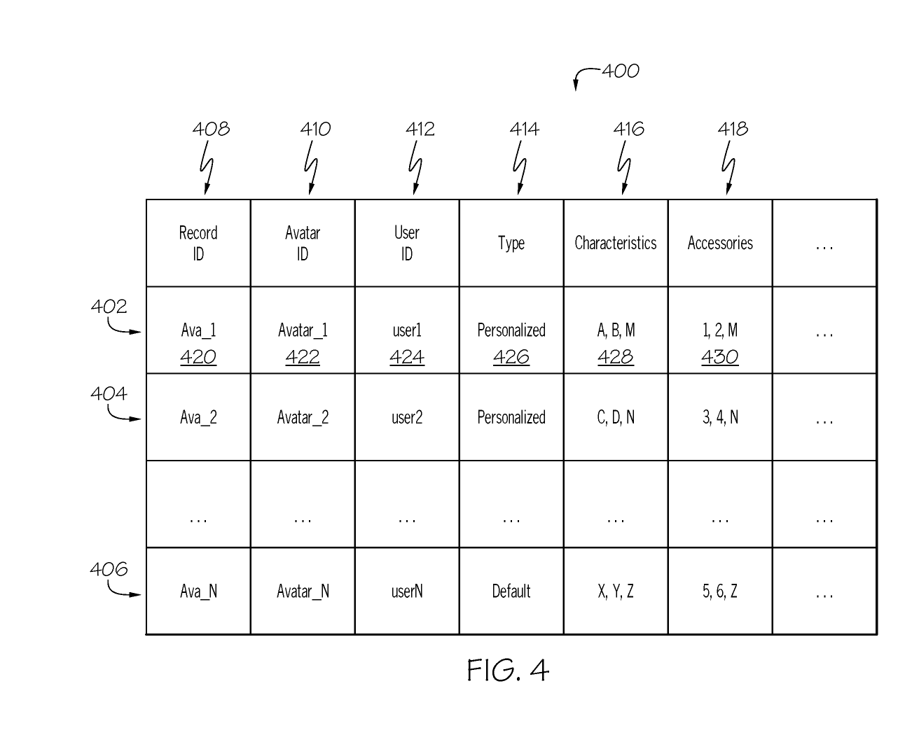

When an avatar 136 is created for a user the avatar 136 is stored and maintained by the virtual environment manager 122. In one embodiment, an avatar profile 134 is also created for this avatar. FIG. 4 shows various examples of avatar profiles 134. In the example shown in FIG. 4, each row 402, 404, 406 in the table 400 corresponds to an avatar profile. It should be noted that in other embodiments, each avatar profile 402, 404, 406 is stored separate from one another. The table 400 comprises a plurality of columns, each storing a different set of information. In this example, the table 400 comprises a first column 408 entitled “Record ID”; a second column 410 entitled “Avatar ID”; a third column 412 entitled “User ID”; a fourth column 414 entitled “Type”; a fifth column 416 entitled “Characteristics”; and a sixth column 418 entitled “Accessories”.

The “Record ID” column 408 comprises entries 420 uniquely identifying each avatar profile in the table 400. The “Avatar ID” column 410 comprises entries 422 uniquely identifying the avatar associated with the avatar profile. The “User ID” 412 column comprises entries 424 identifying the user associated with the avatar. The user ID, in one embodiment, comprises information such as the user login name from the credentials information in the user profile 124, the user profile record ID, and/or the like. The “Type” column 414 comprises entries 426 identifying whether the avatar is a personalized avatar or a default avatar. The “Characteristics” column 416 comprises entries 426 identifying the physical characteristics associated with the avatar. The “Accessories” column 418 comprises entries 428 identifying the accessories associated with the avatar. In one embodiment, the rendering engine 202 utilizes the information from the “Characteristics” and “Accessories” columns 416, 418 to render the avatar within the virtual environment 114.

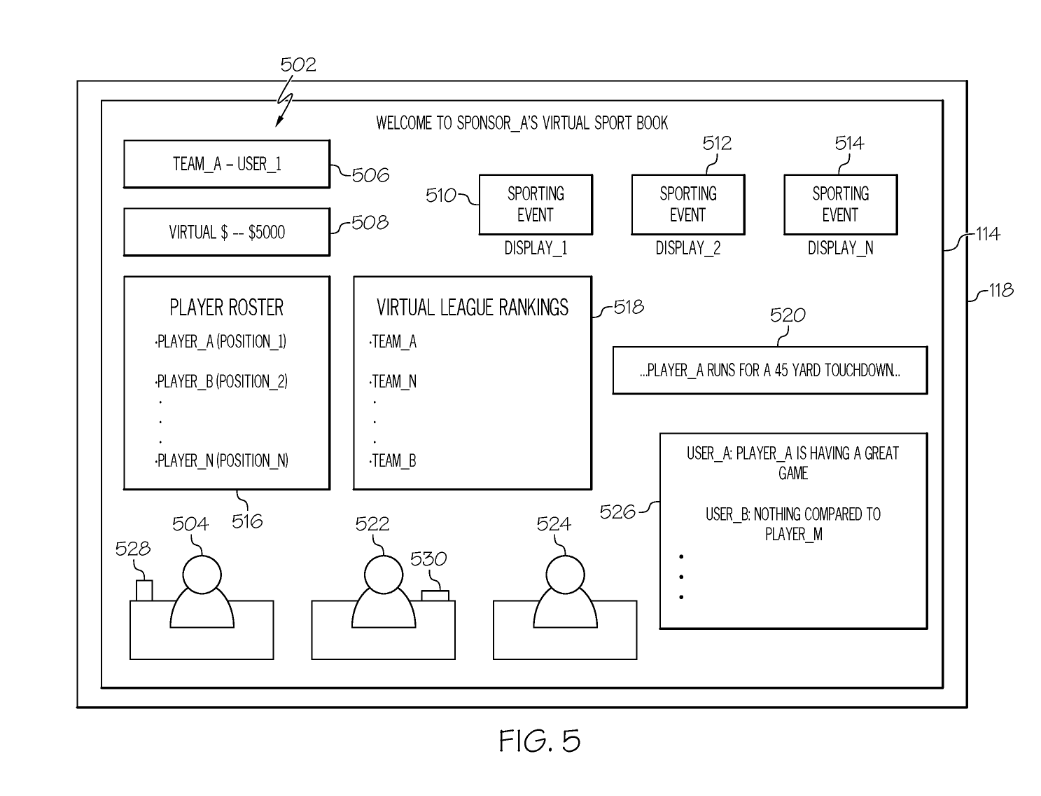

Once the user selects an avatar, the avatar is rendered in the virtual environment 114 via the rendering engine 202. The user, via the interface 118, commands the avatar to enter an area of the virtual environment 114. In one embodiment, the rendering engine 202 presents a first area/location 502 of the environment 114 such as (but not limited to) a virtual sports book to the user, as shown in FIG. 5. In the example shown in FIG. 5, the virtual sports book comprises an identification 504 of the area/location 500 of the environment 114 in which the user's avatar 502 is currently located. If the virtual sports book is sponsored by a given entity the virtual sports book comprises virtual representations of actual decorations, furniture, electronics, and/or the like found in the real-life sports book.

FIG. 5 further shows that the virtual sports book further comprises an identification 506 of the user and, optionally, the user's virtual team. In one embodiment, a virtual currency balance 508 is also displayed. Virtual currency can be awarded to users based on participation in various games hosted by the virtual environment 114, and/or purchased by a user. Virtual currency can be used to buy or obtain coupons for various products and services from sponsors/advertisers, as well as virtual gems and goods, in the virtual environment 114. A plurality of virtual displays 510, 512, 514 such as televisions are also presented to a user in the virtual sports book. In this embodiment, each display presents various types of information to a user such as real-life sporting event information, real-life player information, and/or the like. In one embodiment, actual video of real-life sporting events is presented to a user via one or more of these virtual displays 510, 512, 514.

One portion 516 of the virtual sports book displays information associated with the user's team. For example, FIG. 5 shows that a player roster is displayed to the user. This player roster identifies each player on the user's team, the position of the player, and/or the like. The profile manager 210, in one embodiment, obtains player roster information based on the user's profile 124, team profiles 126, and/or player profiles 128. The user is able to select at least one of the displayed players to have more detailed information, such as (but not limited to) statistics, associated with the selected player presented to the user. Another portion 518 of the virtual sports book comprises league ranking information. For example, this portion 518 of the virtual sports book can display current virtual league standings to the user. The profile manager 210, in one embodiment, obtains the ranking information based on the user's profile 124, team profiles 126, and/or player profiles 128.

The virtual sports book, in one embodiment, also comprises an area 520 that displays real-life game highlights to the user. These highlights can be text-based, video-based, and/or the like. In one embodiment, the virtual environment manager 122 communicates with an external information processing system to obtain video data comprising the real-life game highlights. The virtual environment manager 122 locally stores the video data and/or streams the video data from the external system 110. The virtual sports book also comprises the avatar 504 associated with the user and one or more avatars 522, 524 associated with other users that have entered the virtual sports book. The user is able to select one or more of these avatars 522, 524 for communicating with the user. For example, when the user selects on another user's avatar 522 a messaging windows 526 can be displayed to the user. The users are then able to send one or more messages to each other within the messaging windows 526. It should be noted that the users can also communicate with each other via video, audio, and/or the like. Sponsored or advertised products 528, 530 products are also presented to the user in the virtual sports book. The user is able to select one or more of these sponsored products. In one embodiment, the user utilizes his/her virtual currency to purchase a sponsored/advertised product. When a user selects a sponsored/advertised product, other users are able to see that the user has selected sponsored/advertised products in their view of the virtual sports book.

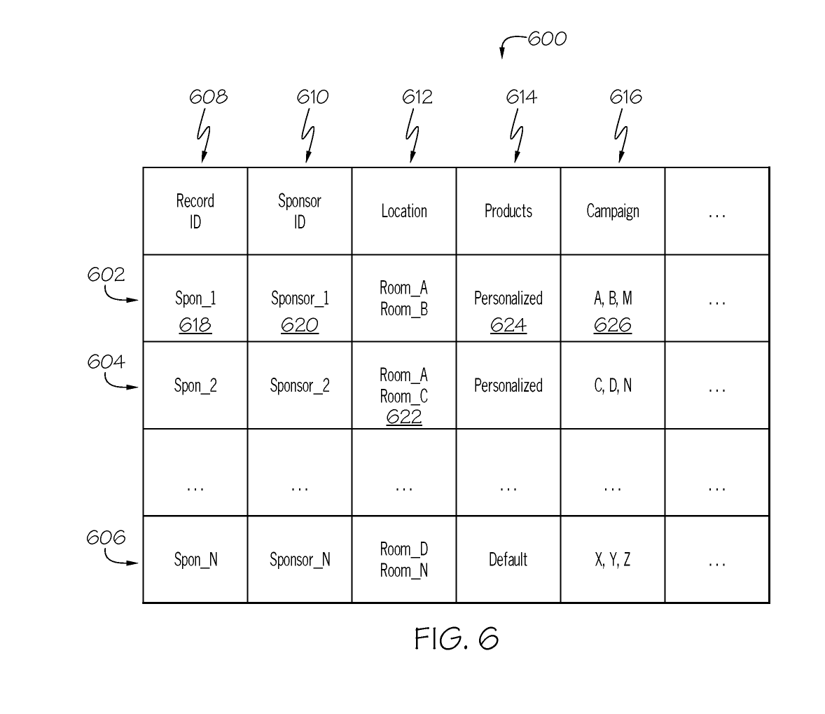

In one embodiment, the profile manager 210 creates and maintains one or more profiles 130 for each sponsor and/or advertiser associated with the virtual environment. FIG. 6 shows various examples of sponsor/advertiser profiles 130. In the example shown in FIG. 6, each row 602, 604, 606 in the table 600 corresponds to a sponsor profile. It should be noted that in other embodiments, each sponsor profile 602, 604, 606 is stored separate from one another. The table 600 comprises a plurality of columns, each storing a different set of information. In this example, the table 600 comprises a first column 608 entitled “Record ID”; a second column 610 entitled “Sponsor_ID”; a third column 612 entitled “Location”; a fourth column 614 entitled “Products”; and fifth column 616 entitled “Campaign”.

The “Record ID” column 608 comprises entries 618 uniquely identifying each sponsor profile in the table 600. The “Sponsor ID” column 610 comprises entries 620 uniquely identifying the sponsor associated with the sponsor profile. The “Location” 612 column comprises entries 622 identifying each location of the virtual environment associated with the sponsor. For example, if a sponsor is sponsoring an entire room of the virtual environment 114 a location entry 622 comprises the identifier of this room such as Room_A or pointer to the record locator in the corresponding user room profiles 132. Location entries 622 can also identify the area of the virtual environment 114 where a sponsor and/or advertiser has their products such as a virtual war room, league drafting center, and/or the like.

The “Products” column 614 comprises entries 624 with identifiers of specific sponsor/advertiser products for each location associated with a sponsor/advertiser. For example, a sponsor/advertiser can have virtual representations of their cigars, beverages, glassware, electronics, appliances, merchandise, and other products displayed and made available within one or more locations of the virtual environment. Pricing information can also be associated with each of these sponsor/advertiser products. For example, a virtual cigar from Entity_A may cost $10 virtual dollars. The “Campaign” column comprises entries 626 including sponsor/advertising campaign information for each sponsor/advertising. Sponsor/advertising campaign information includes, for example, the duration of sponsorship; how often automatic advertisement are to be displayed within the virtual environment; actual advertisements that are to be displayed within the virtual environment; payment/revenue agreements between a sponsor/advertiser and the virtual environment providers; coupons/discounts that are to be provided to users of the virtual environment for virtual and real sponsor/advertiser products and services; and/or the like.

In one embodiment, the users are also presented with one or more fan rooms 142. In one embodiment, fan rooms 142 are rendered and presented to the user in the virtual environment 114 on his/her user device 102. A fan room 142 is a common/public area within the virtual environment 114 associated with theme such as a specific sport, a specific sporting team, and/or the like. Users are able to direct their avatar to a fan room 142 by selecting one or more items displayed within the virtual environment 114. For example, an selectable icon or widget can be presented to the user within the virtual environment 114 that when selected generates a set of instructions executed by the virtual environment manager 122 causing the user's avatar to enter a given fan room 142.

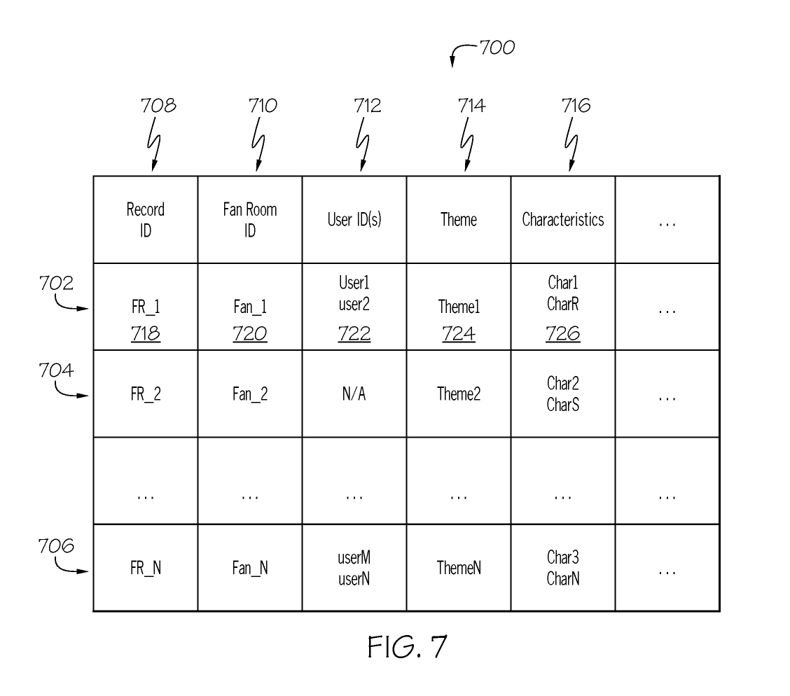

The profile manager 210 maintains a fan room profile 140 for reach fan room provided by the virtual environment 114. FIG. 7 shows various examples of fan room profiles. In the example shown in FIG. 7, each row 702, 704, 706 in the table 700 corresponds to a fan room profile. It should be noted that in other embodiments, each fan room profile 702, 704, 706 is stored separate from one another. The table 700 comprises a plurality of columns, each storing a different set of information. In this example, the table 700 comprises a first column 708 entitled “Record ID”; a second column 710 entitled “Fan Room ID”; a third column 712 entitled “User IDs”; a fourth column 714 entitled “Theme”; and a fifth column 716 entitled “Characteristics”.

The “Record ID” column 708 comprises entries 718 uniquely identifying each fan room profile in the table 700. The “Fan Room ID” column 710 comprises entries 720 uniquely identifying the fan room associated with the fan room profile. The “User IDs” 712 column comprises entries 722 identifying the user(s) (and their avatars) currently located within the room and/or that have previously visited the room. The user IDs, in one embodiment, comprises information such as the user login name from the credentials information in the user profile 124, the user profile record ID, and/or the like. The user ID entry 718 can also comprise a pointer to the user profile 124 of the associated user(s). The “Theme” column 714 comprises entries 724 identifying the theme associated with the room such as a given sport, a given real-life sporting team, and/or the like. The “Characteristics” column 716 comprises entries 726 identifying characteristics/attributes such as the virtual furniture, decorations, memorabilia, appliance items, and television items within the fan room. In one embodiment, the rendering engine 202 utilizes the information from the “Characteristics” columns 716 to render the fan room within the virtual environment 114.

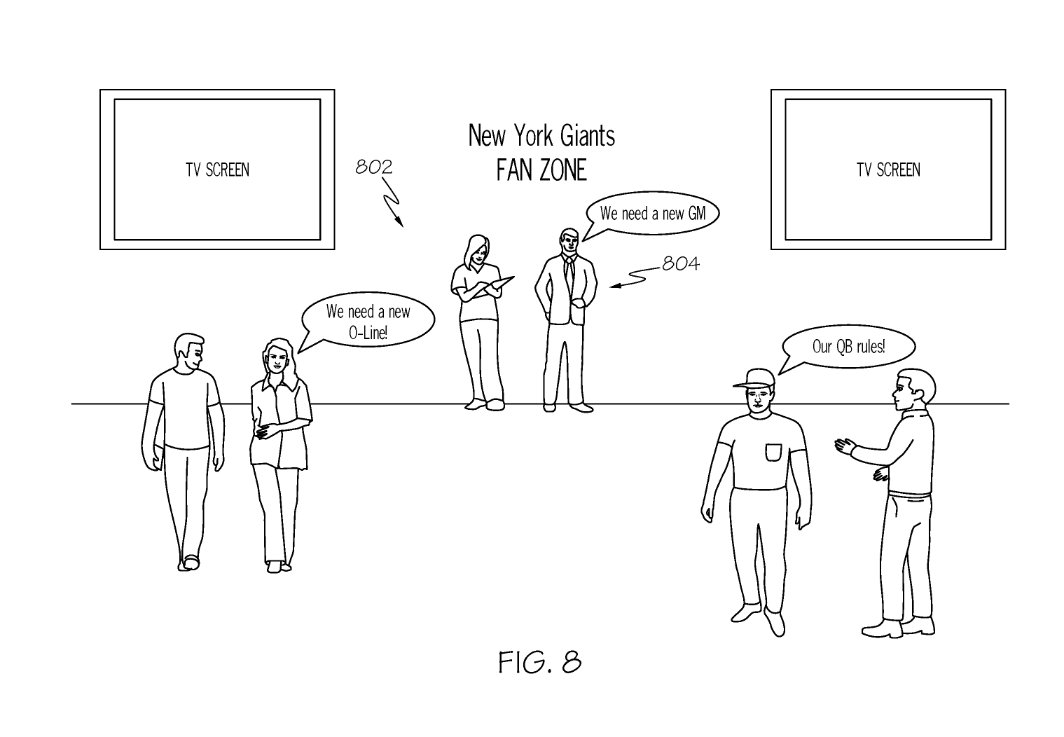

FIG. 8 shows one example of a user fan room. Users that are fans of a given sport, sporting team, and/or the like gather in a common room 802 designated for that sport, team, etc. Users in these rooms can chat with each other 804, show off memorabilia of their favorite team 706, and otherwise engage in an interactive social environment with other fans of a particular sports team.

In addition to the common area (e.g., virtual sports book) and fan rooms of the virtual environment 114, the users are also presented with a player drafting environment. In this embodiment, the players draft players for their virtual sport team(s) by participating in one or more virtual games such as poker, blackjack, and/or the like. When a user logs in to the virtual environment 114 he/she selects their avatar, as discussed above. The user then commands his/her avatar to enter a personalized draft room (also referred to herein as a “war room”). In one embodiment, the user selects a “war room” option presented to the user in the virtual sports book. The user interaction monitor 208 detects this selection and the rendering engine 202 presents a war room. In another embodiment, the rendering engine 202 automatically presents the war room to the user comprising in response to the user logging into the virtual environment and, optionally, selecting his/her avatar.

In one embodiment, a default war room is presented to a user. Alternatively, a personalized war room is presented to the user. In some embodiments, the war room is a virtual representation of the real-life war room of a professional sports team. The user interaction monitor 208 prompts the user to select a default war room or a personalized war room when the user logs into the virtual environment 114 or selects an “enter war room” option. If the user selects a default war room, the rendering engine 202 randomly selects (or generates) a default war room from a plurality of user rooms 138. In one embodiment, the rendering engine 202 presents the user with a list of default (non-personalized) war rooms for selection by the user. The user selects one of these displayed default war rooms via the interface 118. The user can also indicate if he/she wants this selected war room to be the user's default war room. If so, the user's profile 124 is updated to include a pointer to the record in the war room profiles 132 associated with the selected war room. In this embodiment, when a user subsequently commands his/her avatar to enter into a war room the rendering engine 202 automatically selects and displays this default war room to the user via the virtual environment interface 118. The virtual environment interface 118 presents the default war room to the user on his/her device 102.

If the user selects the personalized war room option, the user interaction monitor 208 receives this selection and determines if the user has previously created a personalized war room. For example, the user interaction monitor 208 analyzes the user profile 124 associated with the user, and identifies the “User Rooms” entry. The user interaction monitor 208 determines if this entry identifies a record associated with a personalized war room. If so, the user interaction monitor 208 queries the user to determine if he/she would like to use this personalized war room, update this personalized war room, or create a new one. If the user indicates that he/she wants to use the identified personalized avatar, the rendering engine 202 selects and renders the war room within the virtual environment 114.

If the user indicates that he/she wants to create a new war room or is not currently associated with a personalized war room, the rendering engine 202 presents one or more portions of the virtual environment 114, via the interface 118, which allow the user to create/design a personalized war room. For example, several icons are displayed to the user such as a furniture icon, a memorabilia icon, an appliances icon, and a television icon. The user interaction monitor 208 detects a user's selection of one or more of these icons. If the user selects the furniture icon the rendering engine 202 presents the user with a plurality of virtual furniture (e.g., couches with drink holders) choices to add to his/her war room. If the user selects the memorabilia icon, the rendering engine 202 presents a plurality of memorabilia items (e.g., team helmets, jerseys, etc.) to add to his/ her war room. If the user selects the appliances icon, the rendering engine 202 presents a plurality of appliance items (e.g., different types and models of refrigerators) to add to his/her war room. If the user selects the television icon, the rendering engine 202 presents a plurality of television items to add to his/her war room. Each selection made by the user is identified by the user interaction monitor 208 and recorded in the user profile 124 and/or the user room profile 132 for the room being created.

It should be noted that in one embodiment, the contents of the war room may be sponsored by one or more entities. Sponsors can pay money to promote their name and product(s) and/or enter into a joint marketing agreement where they agree to promote the virtual environment in exchange for the promotion of their name and product(s) in the virtual environment (or the ability to offer discounts or coupons for their product(s)). Sponsorship information is maintained within the user room profile 132 for the room being created and/or the sponsor profile 130 for each of the sponsors.

Once the user is done designing his/her war room, the user selects an option to save the war room. When a war room 138 is created for a user, the war room 138 is stored and maintained by the virtual environment manager 122. When a war room is saved, the rendering engine 202 is able to display this default war room to the user via the virtual environment interface 118. The virtual environment interface 118 presents the default war room to the user on his/her device 102.

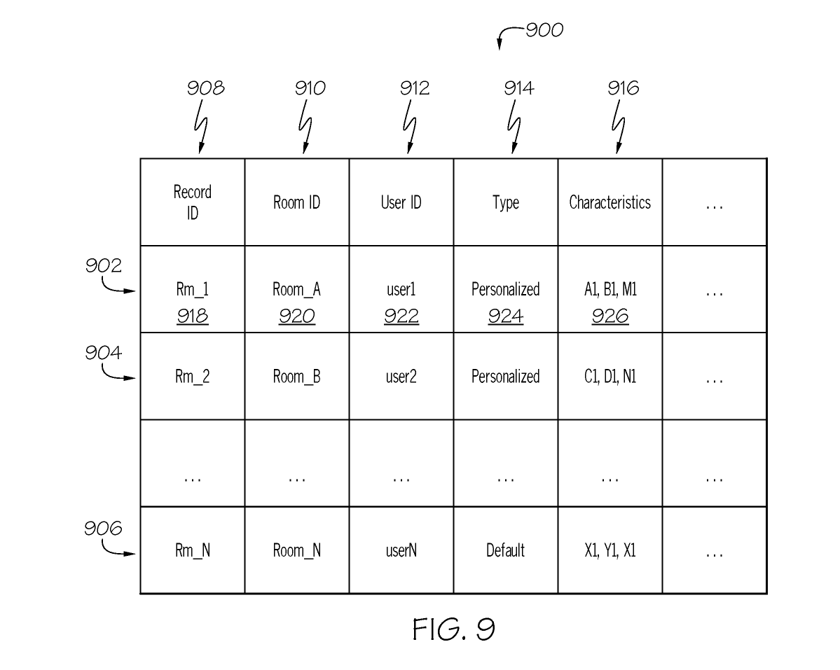

In one embodiment, a user room profile 132 is also created by the profile manager 210. FIG. 9 shows various examples of user room profiles 132. In the example shown in FIG. 9, each row 902, 904, 906 in the table 900 corresponds to a user room profile. It should be noted that in other embodiments, each user room profile 902, 904, 906 is stored separate from one another. The table 900 comprises a plurality of columns, each storing a different set of information. In this example, the table 900 comprises a first column 908 entitled “Record ID”; a second column 910 entitled “Room ID”; a third column 912 entitled “User ID”; a fourth column 914 entitled “Type”; and a fifth column 916 entitled “Characteristics”.

The “Record ID” column 908 comprises entries 918 uniquely identifying each user room profile in the table 900. The “Room ID” column 910 comprises entries 920 uniquely identifying the user room (e.g., war room, trading room, etc.) associated with the user room profile. The “User ID” 912 column comprises entries 922 identifying the user(s) associated with the user room. The user ID, in one embodiment, comprises information such as the user login name from the credentials information in the user profile 124, the user profile record ID, and/or the like. The user ID entry 918 can also comprise a pointer to the user profile 124 of the associated user(s). The “Type” column 914 comprises entries 924 identifying whether the war room is a personalized room, default room, war room, trading room, etc. The “Characteristics” column 916 comprises entries 926 identifying characteristics/attributes such as the virtual furniture, memorabilia, appliance, and television items within the user room. In one embodiment, the rendering engine 202 utilizes the information from the “Characteristics” columns 716 to render the user room within the virtual environment 114.

Each user is able to publicly display their war room designs to other users by clicking on a public option icon within the virtual environment 114. Alternatively, a user is able to make their war room private. Users can send and receive comments to each other about the designs of war rooms for which users have elected the public option. In addition, users can provide a rating for other users' war rooms. These ratings are maintained and compiled by the profile manager 210. The virtual environment manager 122 presents (and updates) a list of the top N war rooms based on the ratings provided by the users. The virtual environment manager 122 also presents a list of the top N most recent war room designs (including enhancements to existing designs) so as to provide an orderly and fair method for users to have their war rooms viewed by other users. Prizes can be awarded for the most highly ranked war room(s). War room ranking information can be stored and maintained by the profile manager 210 within the user profiles 124, the user room profiles 132, and/or the like.

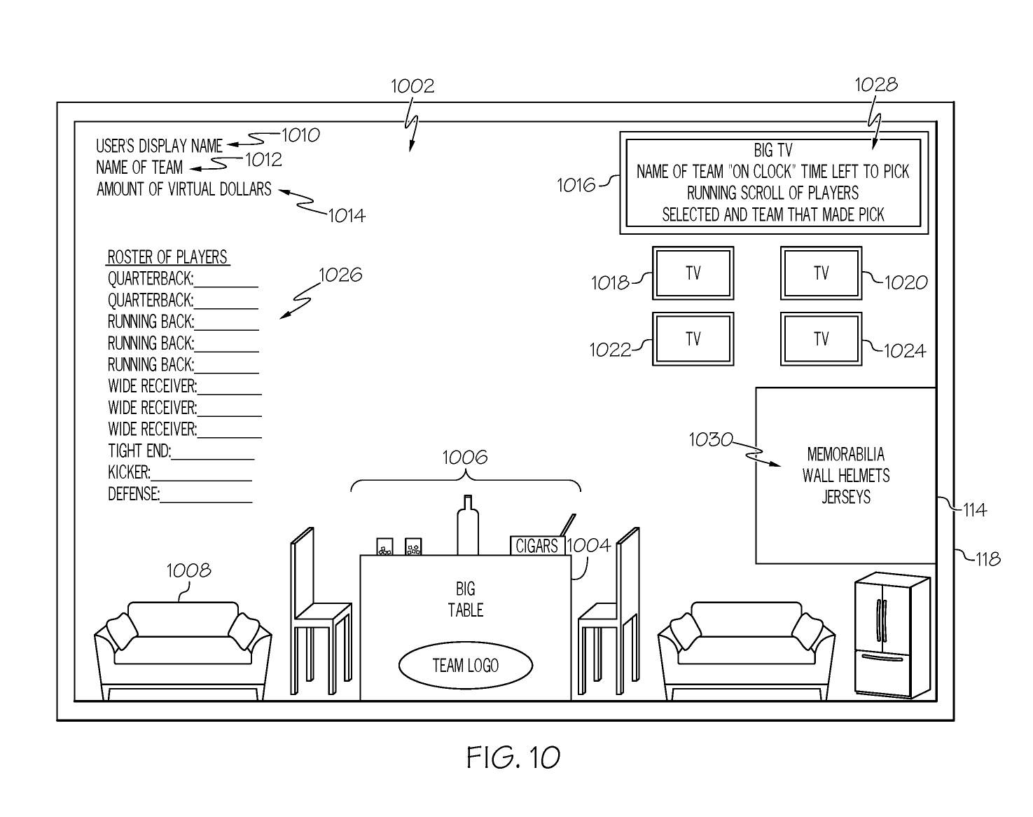

FIG. 10 shows one example of a personalized war room 1002 associated with a user. When a user enters his/her war room 1002 the rendering engine 202 automatically plays audio and/or video (and/or display text) of a welcome message such as “Welcome to the [date] [sport] Draft”. The war room 1002 comprises a virtual table 1004 comprising the user's team logo. The table 1004 also comprises a selection of virtual items 1006 such as drinks, cigars, food, and/or glassware. The virtual drinks, cigars and food may be sponsored in exchange for a fee and/or a joint marketing agreement pursuant to which such sponsor(s) agrees to promote the virtual environment in exchange for the promotion of their name and product(s) in the virtual environment (or the ability to offer discounts or coupons for their product(s)). In one embodiment, the user interaction monitor 208 prompts the user's avatar if it would like a virtual item 1006 such as a drink and/or a cigar stating the respective sponsors names (e.g. “Would you like a Brand X Vodka and a Brand Y cigar?”). After the avatar picks up a virtual item 1006, the avatar takes a seat in a furniture item 1008 of the war room 1002.

The war room 1002 also comprises an identification 1010 of the user such as the user's display name, and an identification 1012 of the user's virtual team. In one embodiment, the user's virtual currency balance 1014 is also displayed. A plurality of virtual displays/televisions 1016 to 1024 is also presented to the user in his/her war room. A draft board 1026, with the user's team name displayed thereon, is also included within the war room 1002. The draft board 1026 shows the various positions that the user needs to fill during the draft (e.g., if the game is virtual football, there may be 2 quarterbacks, 3 running backs, 3 wide receivers, etc.). At least one of the displays 1016 comprises a running scroll 1028 that shows the picks/drafts that each of the users have made prior to the current selection and who is on the clock (i.e., the user whose turn it is to make a selection). Also, as each pick is made, each player's draft board is filled in by position. When it is a user's time to pick, a running clock with the time remaining for the user to make a selection appears on the display 1016.

The war room also comprises any memorabilia 1030 selected by the users during the room designing/enhancing process (or at later point in time). Examples of memorabilia include (but are not limited to) helmets, jerseys, and/or the like. Users can sell and/or trade memorabilia to other users in the virtual environment 114. In addition, virtual representations of real memorabilia owned by the user can be presented in the war room 1002. For example, if the user owns a jersey signed by a specific real-life player, an icon (or other widget) can be displayed within the war room 1002 that represents this signed jersey. When the user (or another user) selects this icon, a photograph or video of the real-life memorabilia item is displayed to the user.

In one embodiment, once all users in a particular virtual sports draft have entered their war rooms, each user selects an icon indicating they are ready for the draft to begin. Once the user interaction monitor 208 determines all users associated with the draft have indicated they are ready, the rendering engine 202 notifies each user that the draft is to begin. For example, a flashing sign appears in each user's war room indicating that the draft is to commence in a specified amount of time with a clock counting down the time being displayed to the users in their war rooms. There may be one or more messages from sponsors during the time prior to the start of the draft.

At the specified time, the virtual environment 114 opens to a gaming room 144, which is associated with a specific virtual game 150, for drafting his/her players. It should be noted that, in one embodiment, the war room is optional and users can directly enter into a draft gaming room 144. In one embodiment, the specific gaming room 144 and its associated game 150 that are presented to the users are predefined for the virtual sports league being participated in by the users. In another embodiment, the users of a specific league each select a virtual game 150 that they participate in for drafting players. The game manager 206 receives and stores these selections. The game manager 206 identifies the virtual game 150 with the most selections and designates this virtual game 150 as the game to be used for drafting players.

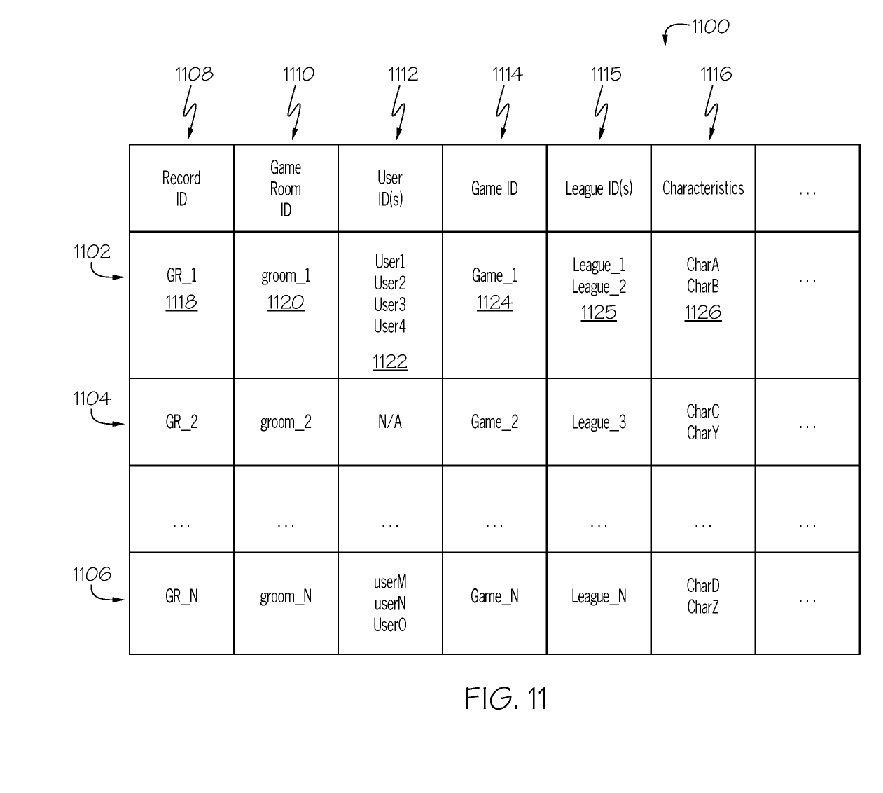

The profile manager 210 maintains a game room profile 140 for each game room provided by the virtual environment 114. FIG. 11 shows various examples of game room profiles. In the example shown in FIG. 11, each row 1102, 1104, 1106 in the table 1100 corresponds to a game room profile. It should be noted that in other embodiments, each game room profile 1102, 1104, 1106 is stored separate from one another. The table 1100 comprises a plurality of columns, each storing a different set of information. In this example, the table 1100 comprises a first column 1108 entitled “Record ID”; a second column 1110 entitled “Game Room ID”; a third column 1112 entitled “User IDs”; a fourth column 1114 entitled “Game ID”; a fifth column 1115 entitled “League ID(s)”, and a sixth column 1116 entitled “Characteristics”.

The “Record ID” column 1108 comprises entries 1118 uniquely identifying each game room profile in the table 1100. The “Game Room ID” column 1110 comprises entries 1120 uniquely identifying the game room associated with the game room profile. The “User IDs” 1112 column comprises entries 1122 identifying the user(s) (and their avatars) currently located within the room and/or that have previously visited the room. The user IDs, in one embodiment, comprises information such as the user login name from the credentials information in the user profile 124, the user profile record ID, and/or the like. The user ID entry 1122 can also comprise a pointer to the user profile 124 of the associated user(s). The “Game ID” column 1114 comprises entries 1124 identifying the Game associated with the room. The game can be identified by its unique identifier and/or its game profile ID. The “League ID(s)” column 1115 comprises entries 1125 identifying the virtual sporting league(s) associated with the game room. The “Characteristics” column 1116 comprises entries 1126 identifying characteristics/attributes such as the virtual furniture, sponsored items, decorations, memorabilia, appliance items, and television items within the game room. In one embodiment, the rendering engine 202 utilizes the information from the “Characteristics” columns 1116 to render the fan room within the virtual environment 114.

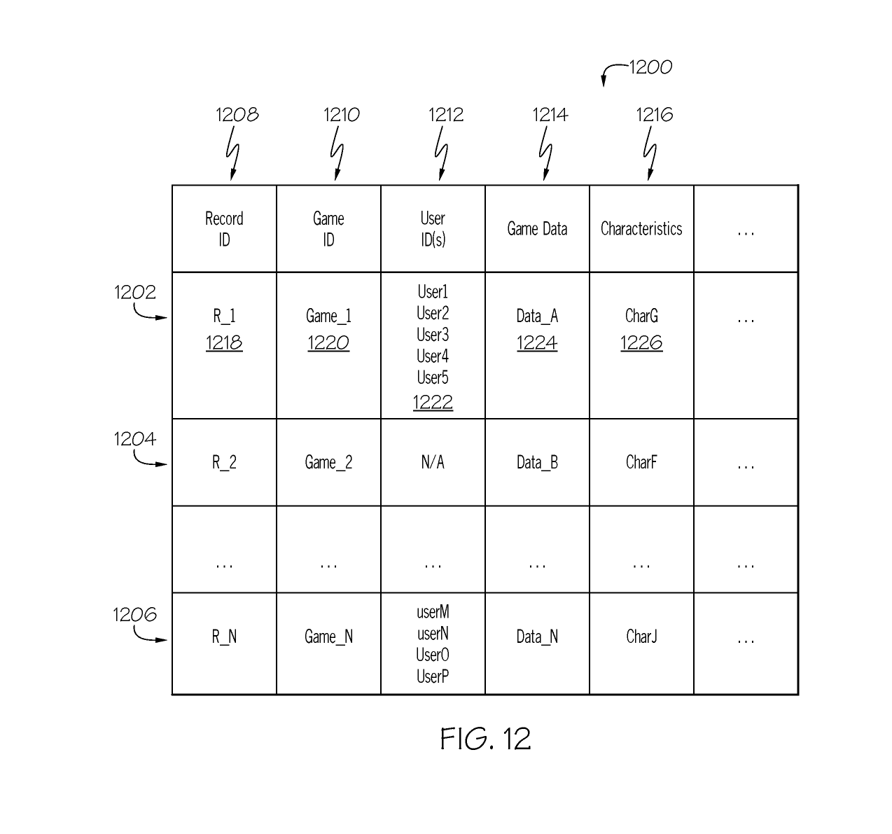

The profile manager 210 also maintains a virtual game profile 146 for each virtual game provided by the virtual environment 114. FIG. 12 shows various examples of game room profiles. In the example shown in FIG. 12, each row 1202, 1204, 1206 in the table 1200 corresponds to a virtual game profile. It should be noted that in other embodiments, each virtual game profile 1202, 1204, 1206 is stored separate from one another. The table 1200 comprises a plurality of columns, each storing a different set of information. In this example, the table 1200 comprises a first column 1208 entitled “Record ID”; a second column 1210 entitled “Game ID”; a third column 1212 entitled “User IDs”; a fourth column 1214 entitled “Game Data”, and a fifth column 1216 entitled “Characteristics”.

The “Record ID” column 1108 comprises entries 1218 uniquely identifying each game profile in the table 1200. The “Game ID” column 1210 comprises entries 1220 uniquely identifying the virtual game associated with the game profile. The “User IDs” 1212 column comprises entries 1222 identifying the user(s) (and their avatars) currently participating in the game and/or that have previously participated in the game. The user IDs, in one embodiment, comprises information such as the user login name from the credentials information in the user profile 124, the user profile record ID, and/or the like. The user ID entry 1222 can also comprise a pointer to the user profile 124 of the associated user(s). The “Game Data” column 1214 comprises entries 1224 with data associated with the game. Game data includes the game type (e.g., poker, blackjack, etc.) associated with the game; game rules; current game play data such as an available player pool, players currently assigned to a displayed card or slot reel entry, players currently held by a user, user actions, etc.; executable instructions and/or code for rendering, presenting, and managing the game; and/or the like. The “Characteristics” column 1216 comprises entries 1226 identifying characteristics/attributes such as the virtual furniture, sponsored items, decorations, memorabilia, appliance items, and television items within the virtual game.

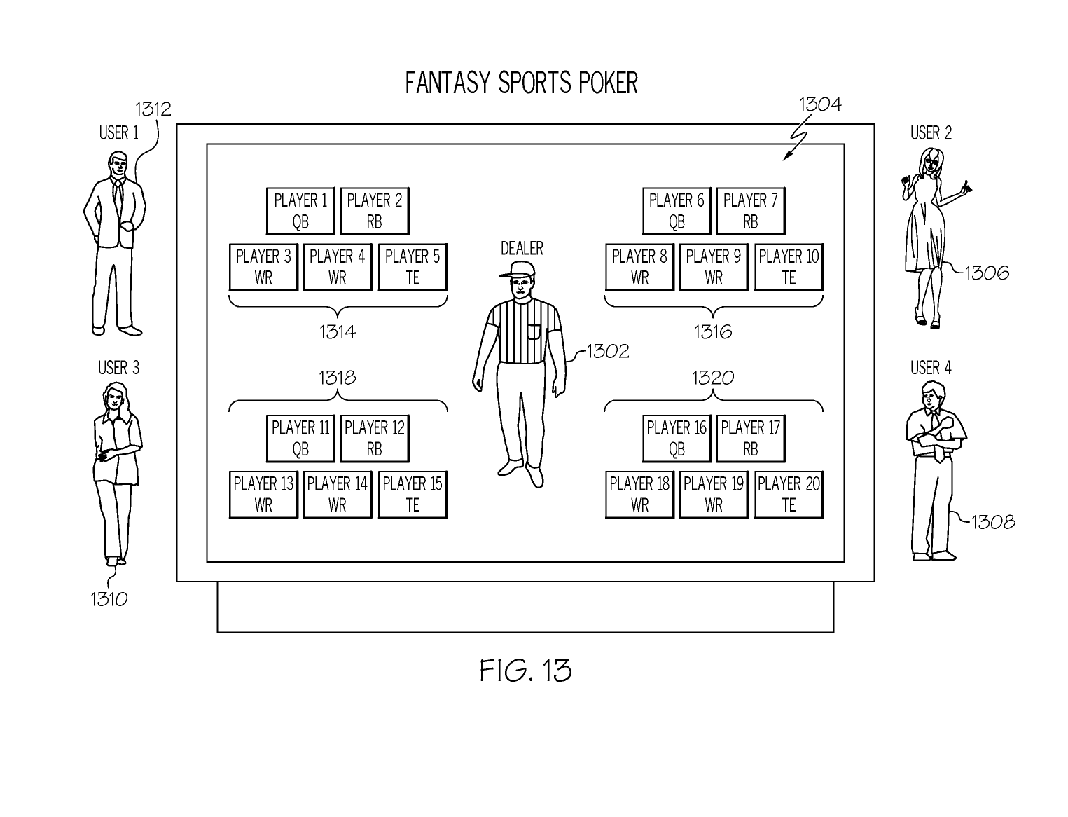

The rendering engine 202 utilizes the data within the game room profiles 144 and virtual game profiles 148 to render game room 146 and its game 150 within the virtual environment 114. The rendered game room 146 and game 150 are presented to the user via the virtual environment interface 118 on the user device 102. In one embodiment, users participate in a virtual game 150 to draft players for a virtual (e.g., fantasy) sports team. For example, users can participate in a 5-card draw poker game, as shown in FIG. 13. It should be noted that alternative number of cards can be utilized as well. Also, there can be a variable number of users playing against each other in any particular game.

In the example shown in FIG. 13, the game manager 206 renders a virtual dealer 1302 within the game room 1304 based on data within the game profile 148 associated with the game being played. The game manager 206 also renders the avatar 1306, 1308, 1310, 1312 of each user participating in the game. The game manager 206 can identify the users and the avatars based on the user profiles 124, avatar profiles 134, game room profiles 144, virtual game profiles 146, and/or the like. The virtual dealer 1302 deals out “cards” 1314, 1316, 1318, 1320 to each avatar 1306, 1308, 13010, 1312 sitting at a virtual poker table 1322. In one embodiment, each card shows the names of the athletes (and their teams) for the particular virtual sport associated with the game 150. Cards can also have up-to-date statistics for each athlete associated with a card and/or real-life pictures of the athlete. A user is able to select a card to view additional information about the user such as statistics associated with the athlete. In one embodiment, the game manager 206 utilizes the game data 1226 within the game profile 148 to identify the players, team, and/or the like to be associated with the cards. Once a card is dealt, the game manager 206 records the card, the athlete associated with the card, the sports team associated with the card, the displayed statistics for the athlete, the user/avatar that has been dealt the card, and/or the like within the game data 1226 for the game.

During the game, virtual cocktail waitresses can be presented to users that serve virtual drinks. The waitresses and drinks can be sponsored by one or more companies. Sponsor data is stored within the sponsor profiles 130. During game play, each user is dealt the 5 cards (or alternative number of cards) based on the positions of the athletes in the particular sport being played. For example, if the game is 5-card draw virtual baseball the first card drawn can be a pitcher card, the second and third cards drawn can be middle infielder cards, and the last two cards drawn can be two outfielder cards. The logic for dealing the cards is stored as game data 1226 within the game profile 148. If the game is 5-card draw virtual football, the first card drawn can be a quarterback, the second card drawn can be a running back, the third and fourth cards drawn can be two wide receivers, and the fifth card drawn can be a tight end. It should be noted that alternative ways for selecting the positions of the athletes used for each type of game being played are applicable as well.

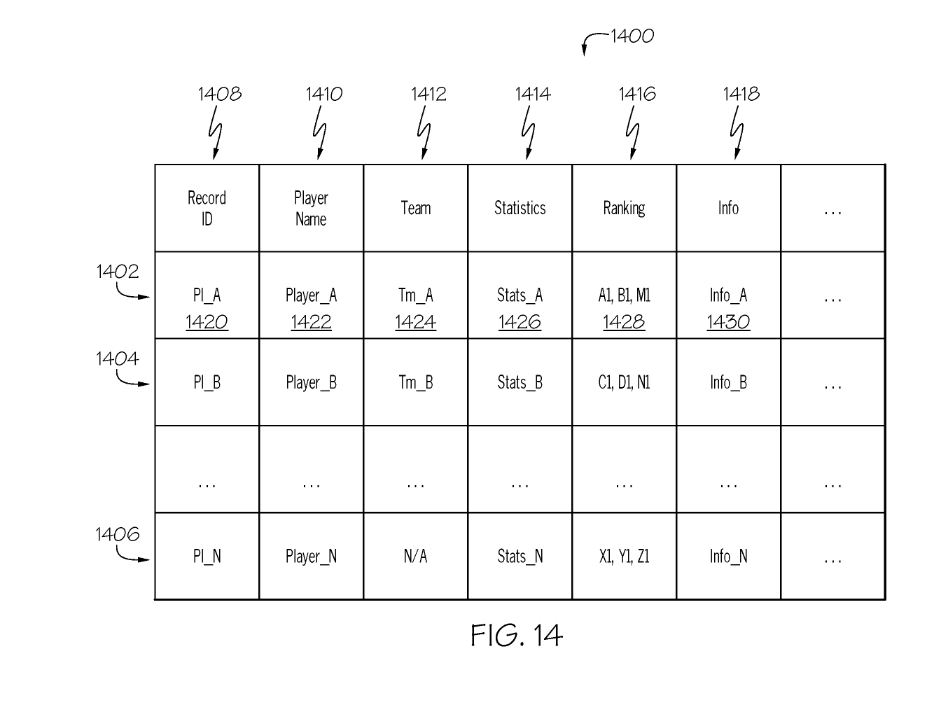

In one embodiment, player profiles 128 are maintained for each athlete in the real-life sport league corresponding to the virtual sport league. The game manager 206 is able to obtain player information from these player profiles 128 for presentation to the user and/or to be displayed on a card. FIG. 14 shows various examples of player profiles. In the example shown in FIG. 14, each row 1402, 1404, 1406 in the table 1400 corresponds to a player profile. It should be noted that in other embodiments, each player profile 1402, 1404, 1406 is stored separate from one another. The table 1400 comprises a plurality of columns, each storing a different set of information. In this example, the table 1400 comprises a first column 1408 entitled “Record ID”; a second column 1410 entitled “Player Name”; a third column 1412 entitled “Team”; a fourth column 1414 entitled “Statistics”; a fifth column 1416 entitled “Ranking”; and a sixth column 1418 entitled “Info”.

The “Record ID” column 1408 comprises entries 1420 uniquely identifying each player profile in the table 1400. The “Player Name” column 1410 comprises entries 1422 with the name of the real-life player associated with the player profile. The “Team” column 1412 comprises entries 1424 with a pointer to a record in the team profiles 126 associated with the virtual league team (if any) who has drafted the player. The “Statistics” column 1414 comprises entries 1426 with statistics and metrics (e.g., real-time and/or historical) associated with the player. In one embodiment, the sporting event data monitor 212 obtains sporting event data 116 associated with the player and updates the “Statistics” entry 1426 associated with the user based on the information therein. The “Ranking” column 1416 comprises entries 1428 with the ranking of the player as determined by draft experts. This information is also obtained by the sporting event data 116 and/or is provided to the virtual environment 114 by one or more draft experts. The “Info” column 320 comprises entries 1430 with various types of information associated with the player such as (but not limited to) position information, physical characteristic information (e.g., height, weight, left-handed, right-handed), and/or the like. It should be noted that the draft manager 204 updates the player profiles 128 based on draft picks during the drafting process discussed above.

After each user receives his/her cards (which are not visible to the other users), the virtual environment manager 122 executes computer instructions causing the virtual dealer 1302 to serially ask each by position if the user would like to keep his/her cards or replace one or more of the cards. This requires each user to determine if it is worth the risk to take a new card to try to get what the user believes will be a better player at each particular position and also requires the users to know the relative value of each athlete in the particular virtual sports game being played. For example, if a user has what he/she believes to be an average pitcher the user decides if it is worth trying to replace that card and receive a new card. Users can take into account such factors as (a) if the card represents a hitter, what pitcher that hitter is facing that day and what are that hitter's statistics against that pitcher or (b) if the card represents a pitcher, what team that pitcher is facing that day and how has that pitcher fared in the past versus that team. The users can select a displayed item within the game room 1304 that displays this information to the user. When the users select this item, the game manager 206 can obtain this data from team or player data stored within a profile or can actively search for this information via the Internet. If a user decides the replace a card, he/she selects an action item within the game room 1304 indicating that he/she would like to replace the card. The user interaction monitor 208 receives and stores this selection. The game manager 206 then instructs the dealer 1302 to remove the selected card and deal and new card to the user. The appropriate profiles are updated accordingly.

In one embodiment, each user is able to designate a double value card, where the points generated by this designated player are increased by a multiplier (e.g., by a factor of 2) when determining a user's final score. Alternatively, this card can have a different assigned value (e.g., triple value). The user interaction monitor 208 receives a user's input designating a multiplied value card. The game manager 206 updates the appropriate profiles accordingly. In another embodiment, the game manager 206 presents a virtual slot machine to the user to determine the multiplied value of a given card. The user selects, for example, the arm of the slot machine, which causes the reels of the machine to spin. After a given amount of time or given number of spins the reel(s) stops and the number(s) on the reel(s) is used as the multiplier value for the card.

Once each user has determined his/her final hand, each user's team for the particular virtual game that day or week the game manager 206 updates the appropriate profiles. Each user's finalized team is revealed to the other users in the game. If a user utilizes a war room, the user's finalized team or picks can be displayed to the user as discussed in the U.S. Provisional Patent Application No. 61/970,520 entitled “Virtual Environment For Virtual Sports Leagues”, which is hereby incorporated by reference in its entirety.

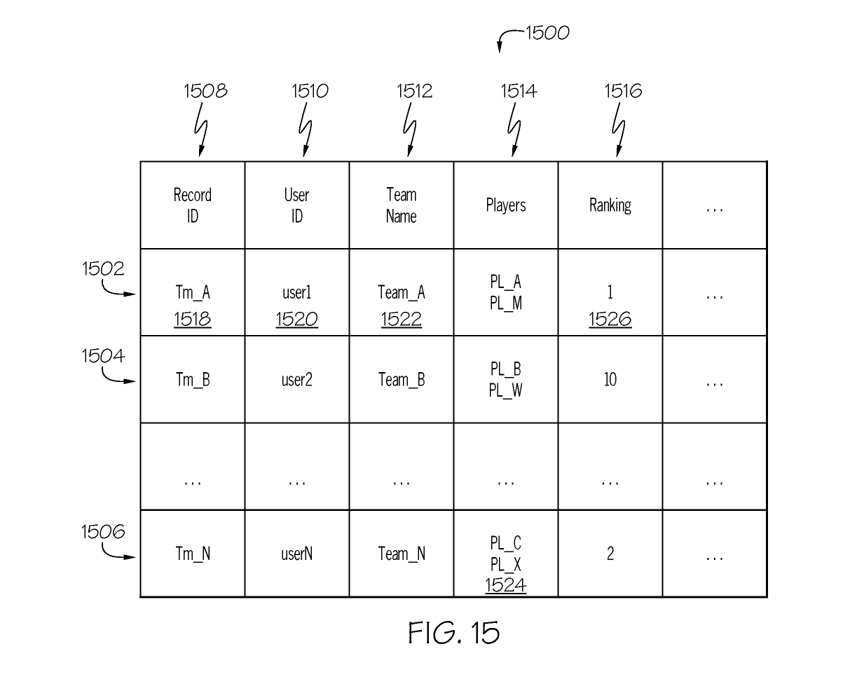

FIG. 15 shows various examples of team profiles 126 maintained by the virtual environment manager 122. In the example shown in FIG. 15, each row 1502, 1504, 1506 in the table 1500 corresponds to a team profile. It should be noted that in other embodiments, each player profile 1502, 1504, 1506 is stored separate from one another. The table 1500 comprises a plurality of columns, each storing a different set of information. In this example, the table 1500 comprises a first column 1508 entitled “Record ID”; a second column 1510 entitled “User ID”; a third column 1512 entitled “Team Name”; a fourth column 1514 entitled “Players”; and a fifth column 1516 entitled “Ranking”.

The “Record ID” column 1508 comprises entries 1518 uniquely identifying each team profile in the table 1500. The “User ID” column 1510 comprises entries 1520 with the user ID of the user associated with the team corresponding to the team profile. The user ID, in one embodiment, comprises information such as the user login name from the credentials information in the user profile 124, the user profile record ID, and/or the like. The user ID entry 1520 can also comprise a pointer to the user profile 124 of the associated user(s). The “Team Name” column 1512 comprises entries 1522 with the name of the team associated with the profile. The “Players” column 1514 comprises entries 1524 with the name of each player drafted by the team associated with the profile and/or the record ID of the player profile 128 associated with each player drafted by the team. The “Ranking” column 1516 comprises entries 1526 identifying the ranking of the team associated with the profile with respect to other teams in the virtual league. The rank of a team can be based on various mechanisms such as (but not limited to) point totals at various granularities. It should be noted that the draft manager 204 updates the team profiles 126 based on draft picks during the drafting process discussed above.

In one embodiment, winners of a virtual sports game are determined by the game manager 206 based on the aggregated statistics compiled by the athletes in the user's final hand for that day (in the case of daily games) or week (in the case of weekly games) in comparison to the aggregated statistics of the players compiled for the other users playing a particular game. For example, the sporting event data monitor 212 obtains statistics for each athlete in a user's final hand from one or more sources and updates the player profile, user profile, and/or the like. Once a time period for a virtual league game such as a day, week, and/or the like has ended, the virtual environment manager 122 aggregates the statistics for each athlete drafted by a user and compares these aggregated statistics to the aggregated statistics of one or more other users in the league. The user with the highest aggregated statistics is designated as the winner that day, week, and/or the like. The virtual environment manager 122 can normalize these statistics by assigning point values to different statistics. For example, consider a 5-card draw virtual baseball game. In this example, the virtual environment manager 122 implements a scoring system where a stating pitcher is awarded 5 points for a win, 0.5 points for each strikeout, and −0.5 points for each earned run; and where a hitter is awarded 1 point for each total base, 1 point for each run scored, 1 point for each RBI (run batted in), 1 point for each stolen base, and −0.5 points for each strikeout.

The virtual environment 114 also provides the users with the ability to place bets with virtual or actual currency to determine the “pot” of currency that can be won for each game. For example, users can place their bets before any card is drawn, after all of the initial cards are drawn, and after the hand is finally determined but before it is revealed to the other players. In another embodiment, there can be a ranking system for the users based on points accumulated, games played and win-loss record. A “world series” of fantasy sports poker hosted by a casino with prizes from sponsors can be made available to users via the virtual environment 114.

In addition, a variety of games for each sport can be generated and made available by the virtual environment manager 122 to users based on the 5-card draw format discussed above. For example, in a baseball virtual league all of the cards can be hitters, where the game is to have the most RBIs or home runs. In another example, all the cards can be pitchers where the game is to have the most strikeouts or fewest earned runs. There can also be several derivative games played in a similar format. For example, there can be a virtual baseball game where the cards are all hitters and the object is to get 21 total bases without going over.

In another embodiment, users can play a game generated within the virtual environment 114 where each user is provided a specified number of cards representing athletes in a particular sport and the object of the game is to place the cards in order from the athlete they think will generate the lowest point total to the athlete they think will generate the highest point total. In this embodiment, users receive a designated number of points for each card placed in proper order. The user with the most points wins the game, with the tiebreaker being the total number of points of the card assigned the highest value. Once each user has selected his/her order, the user's hand and order for the particular game that day or week is revealed by the game manager 206 so the competitors know each other's hand and order.

Winners are determined based on the aggregated statistics compiled by the athletes in the user's hand for that day (in the case of daily games) or week (in the case of weekly games) in comparison to the aggregated statistics of the players compiled for the other users playing a particular game. The number of cards provided to the users can vary and there can be a variable number of users playing against each other in any particular game. There are several alternative mechanisms by which users can be provided the cards. For example, users can be dealt the cards at a virtual casino table or users can pull a lever on a virtual slot machine. Users can be given the ability to get a new hand or pull the slot again if they do not like their hand. In one embodiment, a new hand or an additional pull of the lever in a slot-machine-based game costs virtual or actual currency.

In an alternative embodiment, users have the ability to make bets with virtual or actual currency to determine the “pot” of currency that can be won for each game. In another embodiment, the rendering engine 202 generates an avatar that walks to a board to put the players in the order selected. This avatar can be a representation of a celebrity. The board can relate to the game being played. For example, in a virtual baseball game the board can resemble a baseball field or scoreboard. Prizes can be awarded for players that get all the cards in the proper order. This game can be played in a bracket-style tournament, and there can be several alternative ways for the scoring to be computed such as traditional virtual scoring; total runs; total strikeouts; most touchdowns; etc.

In yet another embodiment, users can play a game generated within the virtual environment 114 where each user is provided a specified number of cards representing athletes in a particular sport and the object of the game is to pick a “low” card (representing the athlete they think will generate the lowest point total) and a “high” card (representing the athlete they think will generate the highest point total). The user with the highest differential between the 2 cards wins the game, with a tiebreaker being the total number of points of the card assigned the highest value. For example, if a player's “low card” gets 5 points and a player's “high card” gets 20 points, that player is awarded 15 points. It is possible to have negative points if the player's “low card” scores more points than the player's “high card”.

Once each user has determined his/her “low card” and “high card”, his/her selections for the particular virtual game that day or week will be revealed so the competitors know each other's selections. Winners are determined based on the aggregated statistics compiled by the athletes in the user's hand for that day (in the case of daily games) or week (in the case of weekly games) in comparison to the aggregated statistics of the players compiled for the other users playing a particular game. The number of cards provided to the users can vary and there can be a variable number of users playing against each other in any particular game. There are several alternative mechanisms by which users can be provided the cards. For example, users can be dealt the cards at a virtual casino table or users can pull a lever on a virtual slot machine. Users can also be given the ability to get a new hand or pull the slot again if they do not like their hand However, in some embodiments, it costs virtual or actual currency to get a new hand or an additional pull of the lever.

Similar to the above, users can have the ability to make bets with virtual or actual currency to determine the “pot” of currency that can be won for each game. There can be an avatar that walks to a board to place the names of the “low card” and “high card” selected by each user. This avatar can be a representation of a celebrity and the board can relate to the game being played. For example, a virtual baseball game can have a board that resembles a baseball field or scoreboard. Prizes can be awarded for players with the highest scores. This game can be also played in a bracket-style tournament. Several alternative ways for computing scores can be utilized such as traditional fantasy scoring; total runs; total strikeouts; most touchdowns; etc.

In a further embodiment, users play a virtual sports game generated within the virtual environment 114 where each user is provided a specified number of cards representing athletes in a particular sport and the object of the game is to have a higher aggregate value of points than the dealer without going over 21 points. The points for the user and the dealer are determined based on the aggregated statistics compiled by the athletes in the dealer's and the user's hands for that day (in the case of daily games) or week (in the case of weekly games). There can be several alternative ways for the scoring to be computed such as traditional fantasy scoring; total runs; total strikeouts; most touchdowns; etc. For example, assume the blackjack game is total bases for baseball games played that day/night. The dealer deals his/herself a specified number of cards (e.g., 3 cards) such as, Buster Posey, David Wright and Robinson Cano. The virtual dealer then deals the user a specified number of cards (e.g., 2 cards) such as Mike Trout and Giancarlo Stanton. The user then has to decide (a) to hold (i.e., not take another card) based on a determination that Mike Trout and Giancarlo Stanton will combine for close to 21 total bases that day/night (or at least more total bases than Buster Posey, David Wright and Robinson Cano) or to “hit” (i.e., take another card). Assume the user decides to “hit” and he receives Alex Gordon and then holds. Whether or not the user wins in this case is determined based on whether Mike Trout, Giancarlo Stanton and Alex Gordon have more total bases than Buster Posey, David Wright and Robinson Cano without going over 21. This virtual game allows a single user to play a game against a virtual dealer. Alternatively, users can play this game in a more social environment similar to blackjack in a real or virtual casino. In one embodiment, users have the ability to make bets with virtual or actual currency to determine the “pot” of currency that can be won for each game. For example, betting can be performed before any card is drawn, after the dealer's cards are drawn and after the user determines his/her final hand In another embodiment, there is a ranking system for the users based on points accumulated, games played and win-loss record. Prizes can be awarded for players who get blackjack (i.e., a total of 21 points).

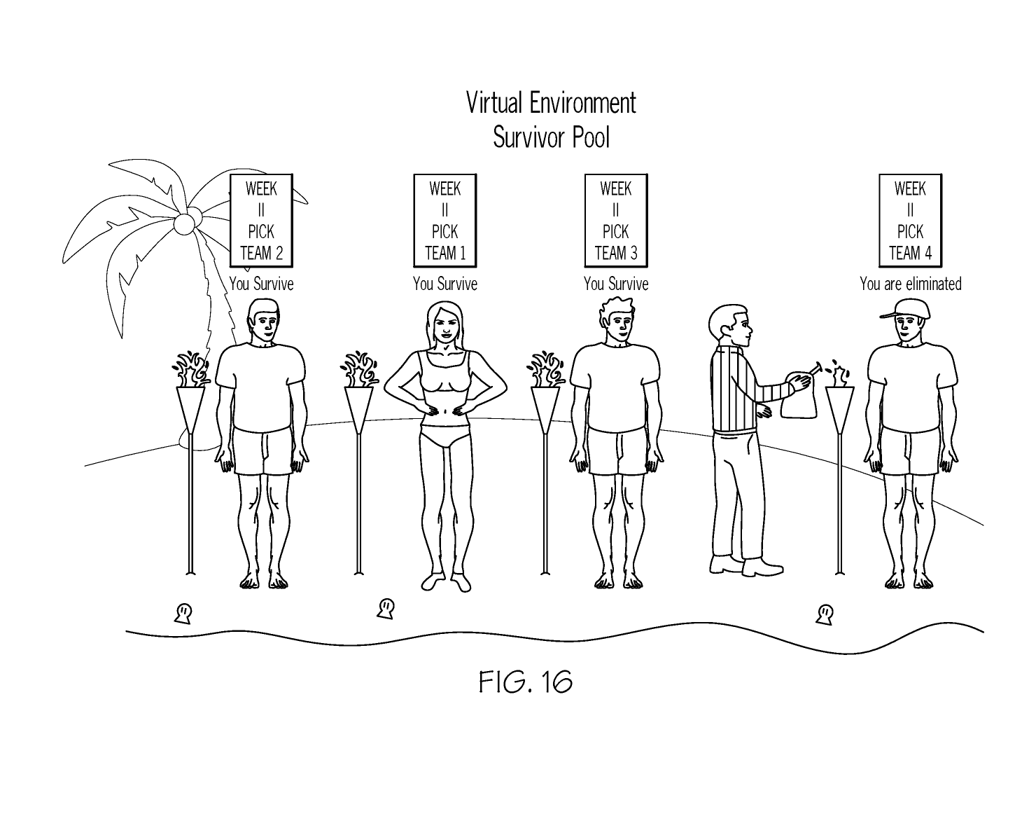

In an additional embodiment, personalized avatars play various “survivor” games in a virtual environment, as shown in FIG. 16. Examples of “survivor” games include (1) a game in which users have to pick one professional football team each week to win and the user cannot pick the same team twice in the season; if the user makes an incorrect choice at any point in time the user is eliminated; the last user to not be eliminated wins the game; and (2) a game in which users have to pick one baseball player each day that will get a base hit (or a home run); if the user makes an incorrect choice at any point in time the user is eliminated; the last user to not be eliminated wins the game. There can be prizes awarded to users from sponsors for the last survivor in each game. The scenery for each “survivor” game can be changed for different survivor themes—a deserted island, a remote snowy area, etc. There can also be a ceremony each day or week (depending on the game) where the contestants who are eliminated have their torches put out, or they are frozen and melt. An avatar of a celebrity can also be presented that puts out a user's torch or that throws a snowball at a user and freezes them, in each case thereby symbolizing the elimination of the user from the game. In addition, if a user orders a specified amount of retail goods from one or more specified retailers, the user can get an advantage in the game (e.g., for the NFL pick survivor game, if the user orders the specified amount of retail goods the user can pick a team that the user picked previously or the user can get two picks that week). If a user is eliminated from the game, that user's avatar can begin to melt, fade away or burn but if the user orders a specified amount of retail goods from one or more specified retailers within a specified amount of time the user can get a new life (and the user's avatar would be made whole again). This retail element presents a novel method for gaming companies to monetize their games because, unlike the conventional methods requiring users to expend real or virtual currency to gain advantages or stay alive in games, this embodiment provides users with goods in addition to gaining advantages or staying alive in games.

In one or more embodiments, all of the foregoing games can be played by using historical data (from a given day, week or different time period from the past). As discussed above, this historical data is stored, for example, in the sporting event data 116. In one embodiment, the virtual environment manager 122 obtains the historical data by establishing a communication session with one or more external information processing systems 110. The virtual environment manager 122 then obtains the data from the external system(s) 110. In another embodiment, the environment manager 122 receives the historical data from one or more external systems utilizing a data push mechanism. In yet another embodiment, the environment manager 122 visits one or more websites comprising sporting data and extracts historical sports data from the websites.

In this manner, the outcome of the games is determined immediately rather than waiting for the results of future real-world sporting events. This allows users to play and obtain results for virtual sports games 24 hours 7 days a week, including during any sport's “offseason”. For example, the virtual environment manager 122 configures a virtual game to deal users a given number of cards (e.g., 5) representing real-world football players and then allowed to trade for different cards from a trade pool with the outcome of the game based on the performance of those football players from week 14 of 2012. Once all trades are completed and a user's hand is established, the results can be computed immediately based on the statistics of each user's players from week 14 of 2012.

One or more embodiments provide a virtual environment that enables users to have their own personalized avatars (including the use of representations of users' own faces). In this virtual environment, users can play a virtual sports game where the drafting of the players for the particular virtual sport being played is conducted by playing poker, blackjack and other games. A dealer in a virtual environment deals out cards that show the names of the sports players, their teams and up-to-date statistics for each athlete in the particular virtual sport being played to the personalized avatars of players sitting around a virtual casino table. In an alternative embodiment, users receive their cards by pulling a virtual lever of a virtual slot machine. Virtual cocktail waitresses are presented in the virtual environment that serve the users virtual drinks. These waitresses and drinks can be sponsored.

Winners of a virtual sports league are determined based on the aggregated statistics compiled by the athletes in the user's final hand of cards for that day (in the case of daily games) or week (in the case of weekly games) in comparison to the aggregated statistics of the players compiled for the other users playing a particular game. There are several alternative methods for determining total points. In addition, users have the ability to make bets with virtual or actual currency to determine the “pot” of currency that can be won for each game. A ranking system can be implemented for the users based on points accumulated, games played and win-loss record. Tournaments can be conducted involving a specified number of users based on these rankings and prizes can be awarded for winners. In another embodiment, personalized avatars in a virtual environment play various “survivor” games where if a user makes an incorrect choice at any point in time the user is eliminated and the last user to not be eliminated wins the game. In addition, if a user orders a specified amount of retail goods from one or more specified retailers, the user can get an advantage in the game or get an additional life in the game. There can be prizes awarded to users from sponsors for the last survivor in each game. Embodiments of the present disclosure are applicable to any sport played throughout the world.

### Operational Flow Diagrams

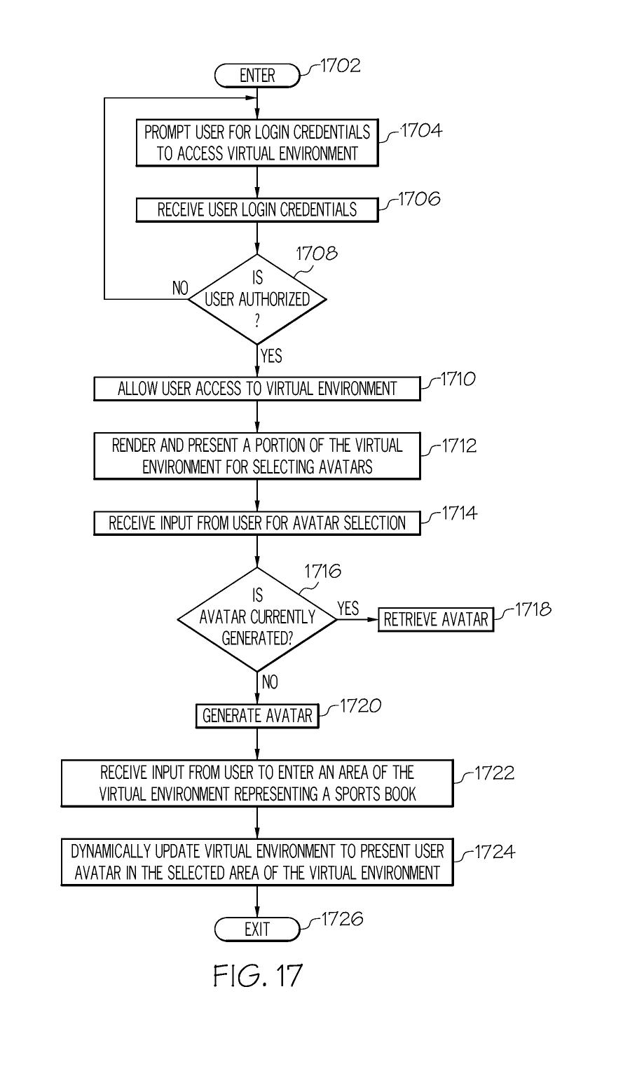

FIGS. 17-23 are operational flow diagrams illustrating various processes of at least one embodiment discussed above with respect to FIGS. 1-16.

FIG. 17 is an operational flow diagram illustrating one example of a process for rendering and populating a virtual environment 114 with an avatar associated with a user. The operational flow diagram of FIG. 17 begins at step 1702 and flows directly to step 1704. The virtual environment manager 122, at step 1704, prompts a user for login credentials to access the virtual environment 114. The virtual environment manager 122, at step 1706, receives user login credentials transmitted from the virtual environment interface 118. The virtual environment manager 122, at step 1708, compares the user login credentials to stored credentials and determines if the user is authorized to access the environment 114. If the result of this determination is negative, the flow returns to step 1704 (or exits and the user is denied access). If the result of this determination is positive, the virtual environment manager 122, at step 1710, allows the user access to the environment 114.

The virtual environment manager 122, at step 1712, renders and presents a portion of the virtual environment 114 to the user. The virtual environment manager 122, at step 1714, receives input from the user for avatar selection. The virtual environment manager 122, at step 1716, determines if the avatar is currently generated/rendered. If the result of this determination is negative, the virtual environment manager 122, at step 1718, retrieves the avatar from memory/storage. The control then flows to step 1722. If the result of this determination is positive, the virtual environment manager 122, at step 1720, renders/generates the avatar. The virtual environment manager 122, at step 1722, receives input from the user to enter an area of the virtual environment 114 such as a sports book area. The virtual environment manager 122, at step 1724, dynamically updates the virtual environment 114 to present the user's avatar in the selected area of the environment 114. The control flow exits at step 1726.

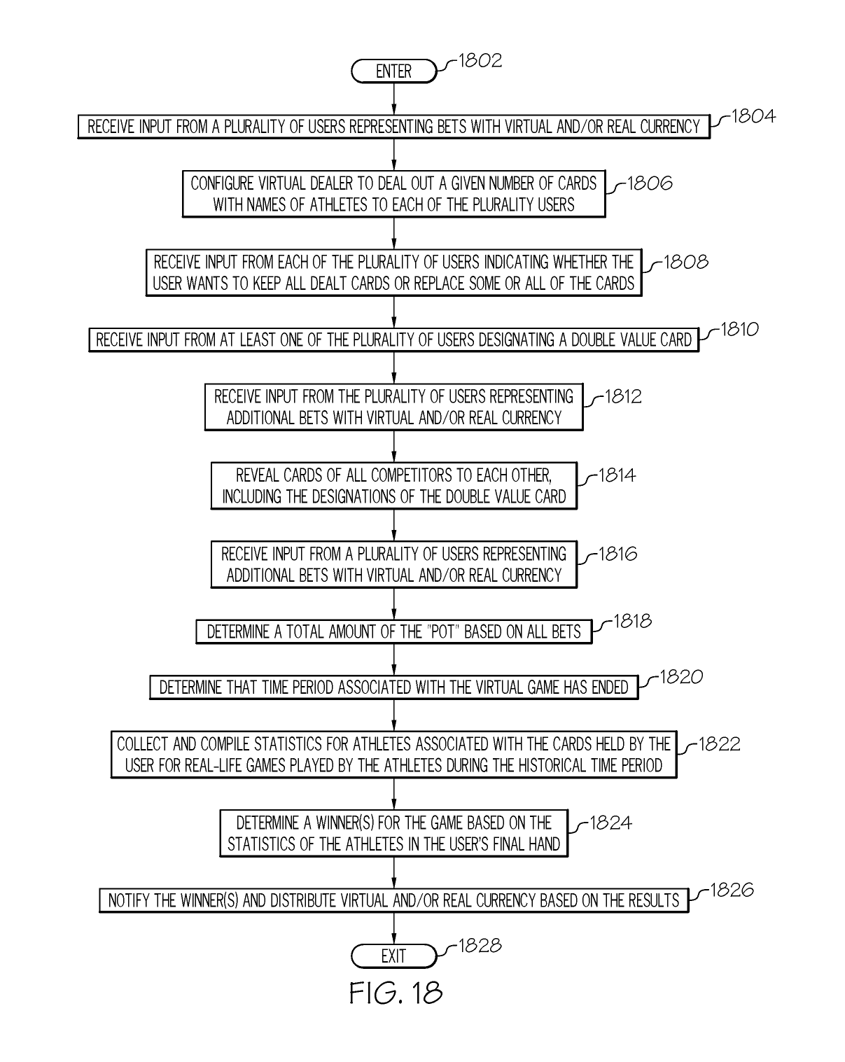

FIG. 18 is an operational flow diagram illustrating one example of a process for generating and managing a virtual sports game where a virtual sports team draft is conducted by presenting a poker game to users with cards having the names of athletes in a virtual environment. The operational flow diagram of FIG. 18 begins at step 1802 and flows directly to step 1804. The virtual environment manager 122, at step 1804, receives input from a plurality of users representing bets with virtual and/or real currency. A user's profile and/or the game profile can be updated to track a user's wagered amount of currency. The virtual environment manager 122, at step 1806, renders and configures a virtual dealer to deal out a given number of cards with names of athletes to each of the plurality of users. Data identifying the current cards dealt to the user are stored within the user and/or game profiles.

The virtual environment manager 122, at step 1808, receives input from each of the plurality of users indicating whether the user wants to keep all dealt cards or replace some or all of the cards. The virtual environment manager 122, at step 1810, receives input from at least one of the plurality of users designating a double value card. The user and/or game profiles are updated to record the user's selection.

The virtual environment manager 122, at step 1812, receives input from the plurality of users representing additional bets with virtual and/or real currency. A user's profile and/or the game profile can be updated to track a user's wagered amount of currency. The virtual environment manager 122, at step 1814, reveals cards of all competitors to each other including the designations of the double value card. The virtual environment manager 122, at step 1816, receives input from at least one of the plurality of users designating a double value card. The user and/or game profiles are updated to record the user's selection.

The virtual environment manager 122, at step 1818, determines a total amount of the “pot” based on all bets. The virtual environment manager 122, at step 1820, determines that a time period (e.g., day, week, month, season, etc.) associated with the virtual game has ended. In another embodiment, the time period is a historical time period that has occurred prior to user playing the game. The virtual environment manager 122, at step 1822, collects and compiles statistics for athletes associated with the cards held by the user for real-life games played by the athletes during the time period. In another embodiment, the collected statistics are historical statistics for a historical time period that has occurred prior to user playing the game. As discussed above, the virtual environment manager 122 establishes a connection with an external information processing system to obtain the statistics and/or extracts the statistics from one or more websites. Alternatively, the statistical data is previously stored by the virtual environment manager 122 in one or more profiles such as the player profiles and obtained therefrom. The virtual environment manager 122, at step 1824, determines a winner(s) for the game based on the statistics of the athletes in the user's final hand. The virtual environment manager 122, at step 1826, notifies the winner(s) and distributes virtual and/or real currency based on the results. The control flow exits at step 1828.

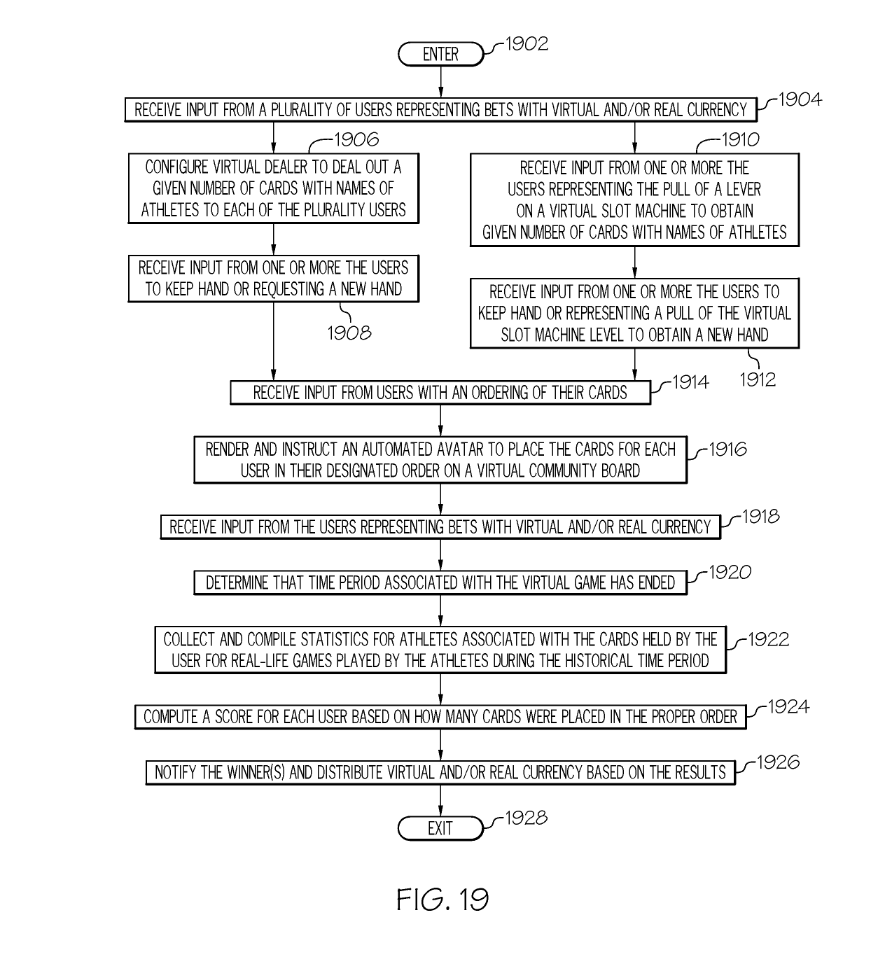

FIG. 19 is an operational flow diagram illustrating one example of a process for generating and managing a virtual sports game where input is received from users to place cards with names of athletes in order from the card that the user predicts will generate the lowest point total to the card that the user predicts will generate the highest point total in a virtual environment. The operational flow diagram of FIG. 19 begins at step 1902 and flows directly to step 1904. The virtual environment manager 122, at step 1904, receives input from a plurality of users representing bets with virtual and/or real currency. The virtual environment manager 122, at step 1906, configures a virtual dealer to deal out a given number of cards with names of athletes to each of the plurality users. The user and/or game profiles are updated to record the user's current cards. The virtual environment manager 122, at step 1908, receives input form one or more of the users to keep his/her current hand or request a new hand If the user requests a new hand, the control flow back to step 1906. If the user indicates that he/she wants to keep the current hand, the control flows to step 1914.

Alternatively or in addition to steps 1906 and 1908, the virtual environment manager 122, at step 1910, receives input from one or more the users representing the pull of a lever on a virtual slot machine to obtain given number of cards with names of athletes. The user and/or game profiles are updated to record the user's selection. The virtual environment manager 122, at step 1912, receives input from one or more the users to keep his/her current hand or an input that represents a pull of the virtual slot machine level to obtain a new hand Once the user provides an input to keep his/her current hand, the control flows to step 1914. The virtual environment manager 122, at step 1914, receives input from users with an ordering of their cards. In one embodiment, the cards are ordered starting with the card that the user predicts will generate the lowest point total and ends with the card that the user predicts will generate the highest point total. The user and/or game profiles are updated to record the users' ordering.

The virtual environment manager 122, at step 1916, renders and instructs an automated avatar to place the cards for each user in their designated order on a virtual community board. The virtual environment manager 122, at step 1918, receives input from the users representing bets with virtual and/or real currency. The user and/or game profiles are updated to record the wagered amount. The virtual environment manager 122, at step 1920, determines that a time period (e.g., day, week, month, season, etc.) associated with the virtual game has ended. In another embodiment, the time period is a historical time period that has occurred prior to user playing the game.

The virtual environment manager 122, at step 1922, collects and compiles statistics for athletes associated with the cards held by the user for real-life games played by the athletes during the time period. In another embodiment, the time period is a historical time period that has occurred prior to user playing the game. As discussed above, the virtual environment manager 122 establishes a connection with an external information processing system to obtain the statistics and/or extracts the statistics from one or more websites. Alternatively, the statistical data is previously stored by the virtual environment manager 122 in one or more profiles such as the player profiles and obtained therefrom. The virtual environment manager 122, at step 1924, computes a score for each user based on how many cards were placed in the proper order. The virtual environment manager 122, at step 1926, notifies the winner(s) and distributes virtual and/or real currency based on the results. The control flow exits at step 1928.

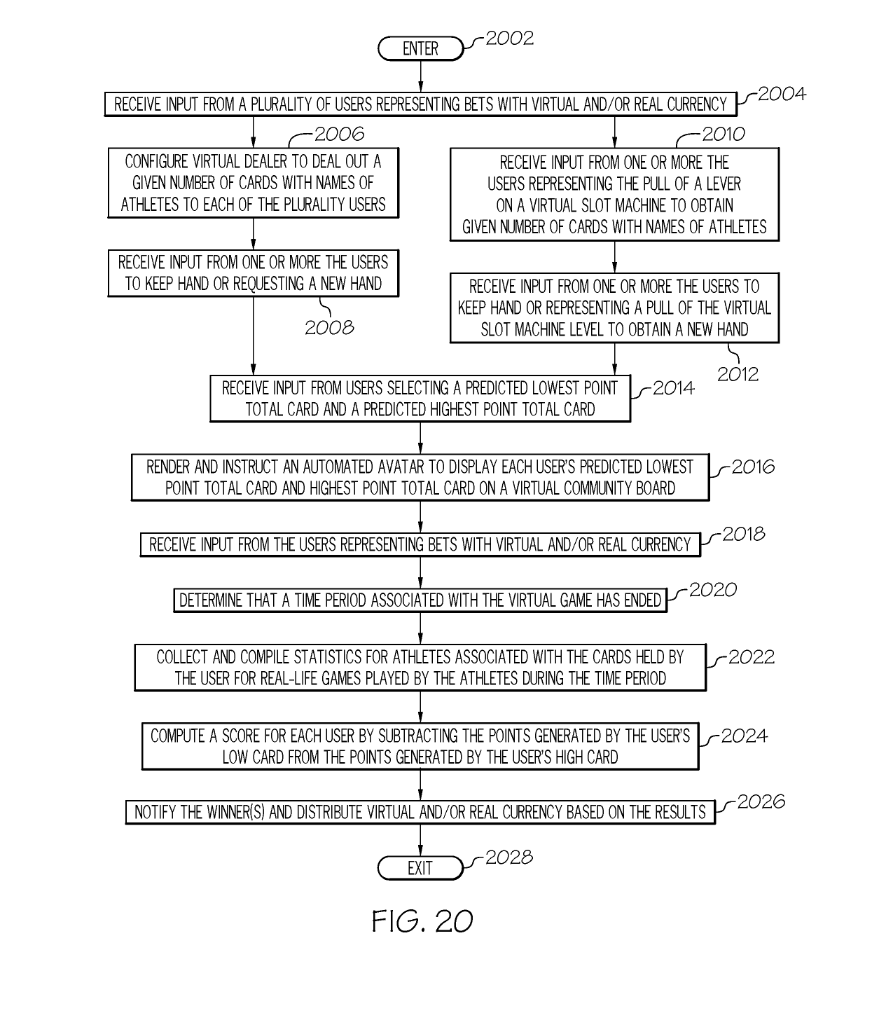

FIG. 20 is an operational flow diagram illustrating one example of a process for generating and managing a virtual sports game where input is received from a user designating a card with a name of an athlete as a low card (i.e., the card that the user predicts will generate the lowest point total) and designating a card with a name of an athlete as a high card (i.e., the card that the user predicts will generate the highest point total) in a virtual environment. The operational flow diagram of FIG. 20 begins at step 2002 and flows directly to step 2004. The virtual environment manager 122, at step 2004, receives input from a plurality of users representing bets with virtual and/or real currency. The virtual environment manager 122, at step 2006, configures a virtual dealer to deal out a given number of cards with names of athletes to each of the plurality users. The user and/or game profiles are updated to record the user's current cards. The virtual environment manager 122, at step 2008, receives input form one or more of the users to keep his/her current hand or request a new hand. If the user requests a new hand, the control flow back to step 2006. If the user indicates that he/she wants to keep the current hand, the control flows to step 2014.

Alternatively or in addition to steps 2006 and 2008, the virtual environment manager 122, at step 2010, receives input from one or more the users representing the pull of a lever on a virtual slot machine to obtain given number of cards with names of athletes. The user and/or game profiles are updated to record the user's selection. The virtual environment manager 122, at step 2012, receives input from one or more the users to keep his/her current hand or an input that represents a pull of the virtual slot machine level to obtain a new hand Once the user provides an input to keep his/her current hand, the control flows to step 2014. The virtual environment manager 122, at step 2014, receives input from users with low card selection and a high card selection. The low card selection identifies the card that the user predicts will generate the lowest point total and the high card selection identifies the card that the user predicts will generate the highest point total. The user and/or game profiles are updated to record the users' selections.

The virtual environment manager 122, at step 2016, renders and instructs an automated avatar to place the cards for each user in their designated order on a virtual community board. The virtual environment manager 122, at step 2018, receives input from the users representing bets with virtual and/or real currency. The user and/or game profiles are updated to record the wagered amount. The virtual environment manager 122, at step 2020, determines that a time period (e.g., day, week, month, season, etc.) associated with the virtual game has ended. In another embodiment, the time period is a historical time period that has occurred prior to user playing the game.

The virtual environment manager 122, at step 2022, collects and compiles statistics for athletes associated with the cards held by the user for real-life games played by the athletes during the time period. In another embodiment, the collected statistics are historical statistics for a historical time period that has occurred prior to user playing the game. As discussed above, the virtual environment manager 122 establishes a connection with an external information processing system to obtain the statistics and/or extracts the statistics from one or more websites. Alternatively, the statistical data is previously stored by the virtual environment manager 122 in one or more profiles such as the player profiles and obtained therefrom. The virtual environment manager 122, at step 2024, computes a score for each user by subtracting the points generated by the user's low card from the points generated by the user's high card. The virtual environment manager 122, at step 2026, notifies the winner(s) and distributes virtual and/or real currency based on the results. The control flow exits at step 2028.

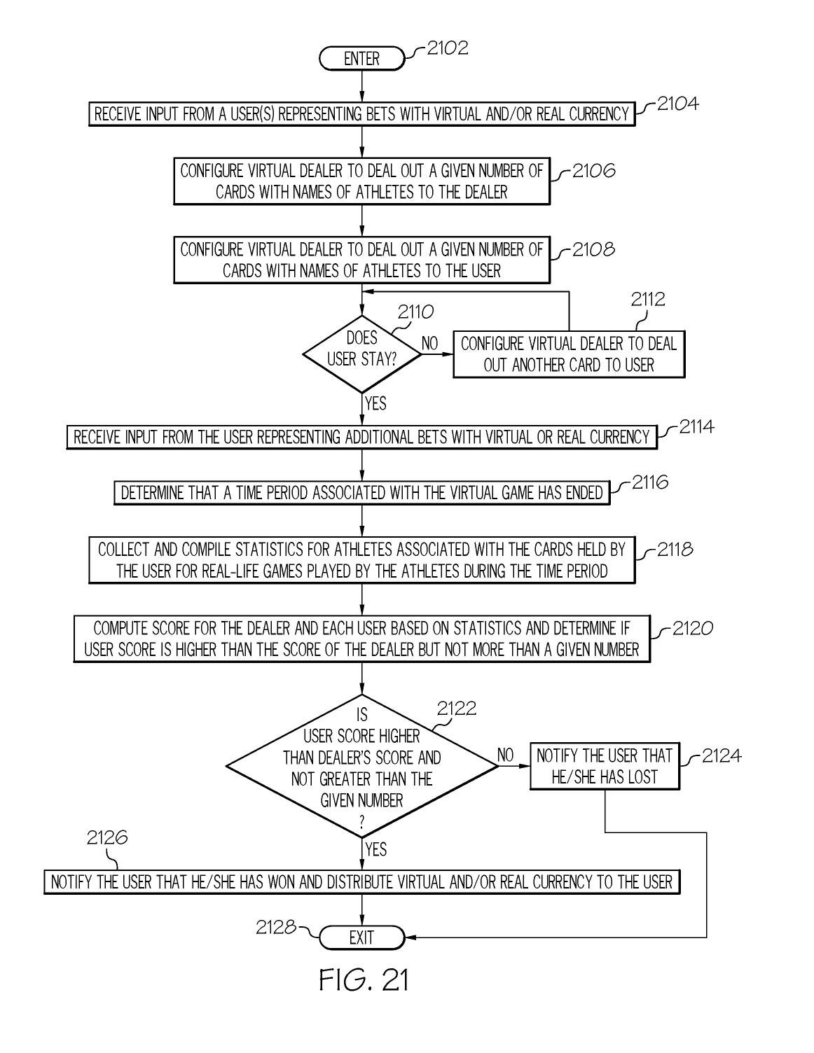

FIG. 21 is an operational flow diagram illustrating one example of a process for generating and managing a virtual sports game where points are given to a user based on the performance of real-life athletes associated with a user's cards, where a user wins or loses the game based on his/her point total as compared to a virtual dealer's point total in a virtual environment. The operational flow diagram of FIG. 21 begins at step 2102 and flows directly to step 2104. The virtual environment manager 122, at step 2104, receives input from a user representing a bet with virtual and/or real currency. The user and/or game profiles are updated to record the user's wagered amounts. The virtual environment manager 122, at step 2106, configures a virtual dealer to deal out a given number of cards with names of athletes to the dealer. The game profile is updated to record the dealer's card.

The virtual environment manager 122, at step 2108, configures the virtual dealer to deal out a given number of cards with names of athletes to the user. The user and/or game profiles are updated to record the user's cards. The virtual environment manager 122, at step 2110, determines if the user has indicated to stay. If the result of this determination is negative, the virtual environment manager 122, at step 2112, configures the virtual dealer to deal out another card to the user. The control flow returns to step 2110. If the result of the determination is positive, the virtual environment manager 122, at step 2114, receives input from the user representing additional bets with virtual or real currency. The user and/or game profiles are updated to record the user's wagered amounts.

The virtual environment manager 122, at step 2116, determines that a time period (e.g., day, week, month, season, etc.) associated with the virtual game has ended. In another embodiment, the time period is a historical time period that has occurred prior to user playing the game. The virtual environment manager 122, at step 2118, collects and compiles statistics for athletes associated with the cards held by the user for real-life games played by the athletes during the time period. In another embodiment, the collected statistics are historical statistics for a historical time period that has occurred prior to user playing the game. As discussed above, the virtual environment manager 122 establishes a connection with an external information processing system to obtain the statistics and/or extracts the statistics from one or more websites. Alternatively, the statistical data is previously stored by the virtual environment manager 122 in one or more profiles such as the player profiles and obtained therefrom.

The virtual environment manager 122, at step 2120, computes a score for the dealer and the user based on the collected statistics. The virtual environment manager 122, at step 2122, determines if the user's score is higher than the score of the dealer, but no more than a given number (e.g., 21). If the result of this determination is negative, the virtual environment manager 122, at step 2124, notifies the user that he/she has lost. The control flow then exits at step 2128. The result of this determination is positive, the virtual environment manager 122, at step 2126, notifies the user that he/she has won and distributes virtual and/or real currency to the user. The control flow then exits at step 2128.

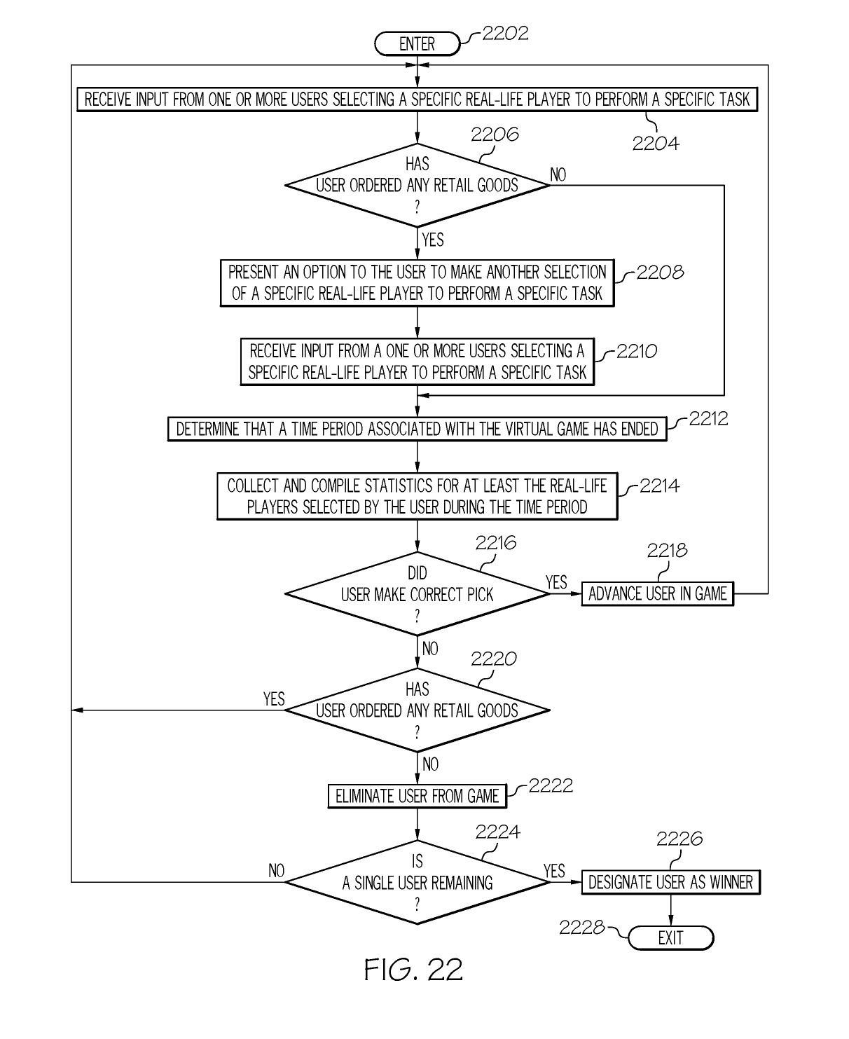

FIG. 22 is an operational flow diagram illustrating one example of a process for generating and managing a virtual sports survivor pool game in a virtual environment. The operational flow diagram of FIG. 22 begins at step 2202 and flows directly to step 2104. The virtual environment manager 122, at step 2204, receives input from one or more users selecting a specific real-life player to perform a specific task. For example, the user can select a specific baseball player to perform a specific task related to baseball such as get a hit. In some embodiments, the users can select multiple tasks to be performed at one or more levels of granularity. For example, a user can select a specific baseball player to get two hits in a game, get two hits back-to-back, get a double in the seventh inning, etc. In one or more embodiments, as the number tasks and/or the level of granularity of the tasks increases so does the “pot”. The “pot” can increase by a given amount or a multiplier can be applied to the pot based on the number tasks and/or the level of granularity of the tasks. The user and/or game profiles are updated to record the user's selection.

The virtual environment manager 122, at step 2206, determines if the user has ordered any retail goods through one or more options presented in the virtual environment. This determination can be made based on information within the user profiles, sponsor profiles, messages sent to the manager 122 from the sponsors, monitored activity data associated with the user, and/or the like. In one embodiment, virtual environment manager 122 receives an input indicating that the user has ordered a specified amount of retail goods from one or more specified retailers

If the result of the determination at step 2206 is negative, the control flows to step 2212. If the result of this determination is positive, the virtual environment manager 122, at step 2208, presents the user with another opportunity to select another real-life player to perform a specific task. The virtual environment manager 122, at step 2210, receives input from the user selecting a specific real-life player to perform a specific task, as discussed above. The user and/or game profiles are updated to record the user's selection.

The virtual environment manager 122, at step 2212, determines that a time period (e.g., day, week, month, season, etc.) associated with the virtual game has ended. In another embodiment, the time period is a historical time period that has occurred prior to user playing the game. The virtual environment manager 122, at step 2214, collects and compiles statistics for athletes associated with the cards held by the user for real-life games played by the athletes during the time period. In another embodiment, the collected statistics are historical statistics for a historical time period that has occurred prior to user playing the game.

The virtual environment manager 122, at step 2216, analyzes the statistics to determine if the user made the correct pick. For example, if the user selected Player_A to perform Task_A, the virtual environment manager 122 analyzes the statistics to determine if Player_A did in fact perform Task_A. If the result of this determination is positive, the virtual environment manager 122, at step 2218, advances the user in the game. The control flow returns to step 2204 where the virtual environment manager receives input from the user selecting a specific real-life player to perform a specific task in the next round. If the result of the determination at step 2216 is negative, the virtual environment manager 122, at step 2220, determines if the user has ordered any retail goods through one or more options presented in the virtual environment. If the result of this determination is positive, the control flows to step 2218. If the result of this determination is negative, the virtual environment manager 122, at step 2222, eliminates the user from the game. The virtual environment manager 122, at step 2224, determines if a single user remains in the game. If the result of this determination is negative, the control flows to step 2204. If the result of this determination is positive, the virtual environment manager 122, at step 2226, designates the user as the winner and distributes virtual and/or real currency to the user. The control flow exits at step 2228.

### Information Processing System

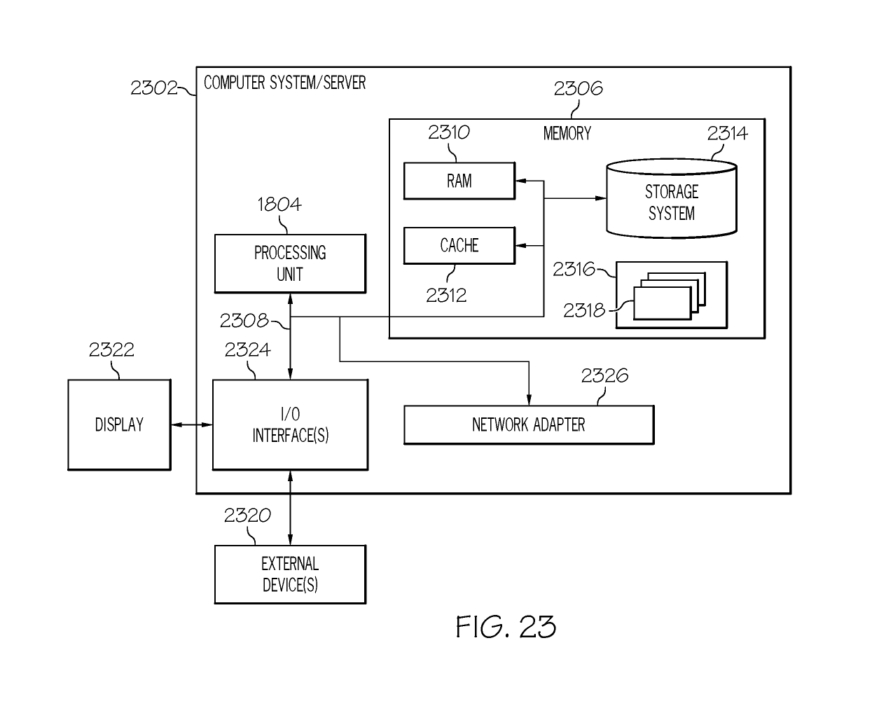

FIG. 23 shows a block diagram illustrating an information processing system 2300 that can be utilized in various embodiments of the present disclosure such as the information processing systems 106, 108 shown in FIG. 1. The information processing system 2300 manages the virtual environment 114, user's interaction with the environment 114, manages the games played by users, receives inputs from users during games, and/or the like. The information processing system 2302 is based upon a suitably configured processing system configured to implement one or more embodiments of the present disclosure. Any suitably configured processing system can be used as the information processing system 2302 in embodiments of the present disclosure. The components of the information processing system 2302 can include, but are not limited to, one or more processors or processing units 2304, a system memory 2306, and a bus 2308 that couples various system components including the system memory 2306 to the processor 2304.

The bus 2308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 23, the main memory 2306 includes at least the virtual environment manager 122 and its components shown in FIG. 1. Each of these components can reside within the processor 2304, or be a separate hardware component. The system memory 2306 can also include computer system readable media in the form of volatile memory, such as random access memory (RAM) 2310 and/or cache memory 2312. The information processing system 2302 can further include other removable/non-removable, volatile/non-volatile computer system storage media. By way of example only, a storage system 2314 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 2308 by one or more data media interfaces. The memory 2306 can include at least one program product having a set of program modules that are configured to carry out the functions of an embodiment of the present disclosure.

Program/utility 2316, having a set of program modules 2318, may be stored in memory 2306 by way of example, and not limitation, as well as an operating system, one or more application programs, other program modules, and program data. Each of the operating system, one or more application programs, other program modules, and program data or some combination thereof, may include an implementation of a networking environment. Program modules 2318 generally carry out the functions and/or methodologies of embodiments of the present disclosure.

The information processing system 2302 can also communicate with one or more external devices 2320 such as a keyboard, a pointing device, a display 2322, etc.; one or more devices that enable a user to interact with the information processing system 2302; and/or any devices (e.g., network card, modem, etc.) that enable computer system/server 2302 to communicate with one or more other computing devices. Such communication can occur via I/O interfaces 2324. Still yet, the information processing system 2302 can communicate with one or more networks such as a local area network (LAN), a general wide area network (WAN), and/or a public network (e.g., the Internet) via network adapter 2326. As depicted, the network adapter 2326 communicates with the other components of information processing system 2302 via the bus 2308. Other hardware and/or software components can also be used in conjunction with the information processing system 2302. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, with an information processing system, for managing a virtual sports league interactive environment, the method comprising:
generating at least one virtual representation of a user for a virtual sports league interactive environment, the virtual representation comprising at least one real facial feature of the user;
conducting a draft of the players for the particular virtual sports league by playing a 5 card (or an alternative number) draw poker game;
generating a dealer in a virtual environment that deals out “cards” that show the names of the sports players (and their teams) in the particular virtual sports league being played to the personalized avatars of players sitting around a virtual casino table;
instructing the dealer to ask the user if the user would like to keep his/her cards or replace one or more of the cards;
instructing each user designate a double value (or alternative value) card-- the points generated by this designated player will be multiplied by 2 (or alternative value) in determining a user's final score; and
determining winners based on aggregated historical statistics compiled by the athletes in the user's final hand for a given historical period of time that has occurred prior to conducting the draft in comparison to aggregated historical statistics compiled for athletes in the final hand of the other users for the same given historical period of time.

2. The method of claim 1, wherein users can have the ability to make bets with virtual or actual currency to determine the “pot” of currency that can be won for each game.

3. The method of claim 1, comprising a ranking system for the users based on points accumulated, games played and win-loss record.

4. A method, with an information processing system, for managing a virtual sports league interactive environment, the method comprising:
generating at least one virtual representation of a user for a virtual sports league interactive environment, the virtual representation comprising at least one real facial feature of the user;
generating a dealer in a virtual environment that deals out “cards” that show the names of the sports players (and their teams) in the particular virtual sports league being played to the personalized avatars of players sitting around a virtual casino table;
instructing the user to place the cards in order from the athlete they think will generate the lowest point total to the athlete they think will generate the highest point total with the user with the most cards in the proper order winning the game (and the tiebreaker being the total number of points of the card assigned the highest value);
instructing a virtual representation to walk to and touch a common board viewable by all users associated with the particular game being played, which common board is then automatically updated based on each user's selections; and
determining winners based on aggregated historical statistics compiled by the athletes in the user's final hand for a given historical period of time that has occurred prior to conducting the draft in comparison to aggregated historical statistics compiled for athletes in the final hand of the other users for the same given historical period of time.

5. The method of claim 4, wherein users would receive their cards by pulling a lever on a virtual slot machine.

6. The method of claim 4, wherein users can have the ability to make bets with virtual or actual currency to determine the “pot” of currency that can be won for each game.

7. The method of claim 4, comprising a ranking system for the users based on points accumulated, games played and win-loss record.

8. A method, with an information processing system, for managing a virtual sports league interactive environment, the method comprising:
generating at least one virtual representation of a user for a virtual sports league interactive environment, the virtual representation comprising at least one real facial feature of the user;
generating a dealer in a virtual environment that deals out “cards” that show the names of the sports players (and their teams) in the particular virtual sports league being played to the personalized avatars of players sitting around a virtual casino table;
instructing the user to designate a “low” card (representing the athlete they think will generate the lowest point total) and a “high” card (representing the athlete they think will generate the highest point total), with the user with the highest differential between the 2 cards winning the game (and the tiebreaker being the total number of points of the card assigned the highest value);
instructing a virtual representation to walk to and touch a common board viewable by all users associated with the particular game being played, which common board is then automatically updated based on each user's selections; and
determining winners based on aggregated historical statistics compiled by the athletes in the user's final hand for a given historical period of time that has occurred prior to conducting the draft in comparison to aggregated historical statistics compiled for athletes in the final hand of the other users for the same given historical period of time.

9. The method of claim 8, wherein users would receive their cards by pulling a lever on a virtual slot machine.

10. The method of claim 8, wherein users can have the ability to make bets with virtual or actual currency to determine the “pot” of currency that can be won for each game.

11. The method of claim 8, comprising a ranking system for the users based on points accumulated, games played and win-loss record.

12. A method, with an information processing system, for managing a virtual sports league interactive environment, the method comprising:
generating at least one virtual representation of a user for a virtual sports league interactive environment, the virtual representation comprising at least one real facial feature of the user;
generating a dealer in a virtual environment that deals out “cards” that show the names of the sports players (and their teams) in the particular virtual sports league being played to the personalized avatars of players sitting around a virtual casino table, as well as to the dealer;
instructing the user to either hold (i.e., not take another card) or to “hit” (i.e., take another card) after receiving the initial two cards from the dealer, with the object being to score more points than the dealer without going over 21 points; and
determining winners based on aggregated historical statistics compiled by the athletes in the user's final hand for a given historical period of time that has occurred prior to conducting the draft.

13. The method of claim 12, wherein users would receive their cards by pulling a lever on a virtual slot machine.

14. The method of claim 12, wherein users can have the ability to make bets with virtual or actual currency to determine the “pot” of currency that can be won for each game.

15. The method of claim 12, comprising a ranking system for the users based on points accumulated, games played and win-loss record.

16. A method, with an information processing system, for managing a virtual sports league interactive environment, the method comprising:
generating at least one virtual representation of a user for a virtual sports league interactive environment, the virtual representation comprising at least one real facial feature of the user;
instructing users to make selections in various “survivor” games where if a user makes an incorrect selection at any point in time during the game the user is eliminated with the last user to not be eliminated winning the game; and
determining winners based on the results of specified athletic events that have occurred during a given historical time period.

17. The method of claim 16, wherein the scenery for each “survivor” game can be changed for different survivor themes—a deserted island, a remote snowy area, etc.

18. The method of claim 16, wherein there can be a ceremony each day or week (depending on the game) where the contestants who are eliminated have their torches put out, or they are frozen and melt.

19. The method of claim 16, wherein if a user orders a specified amount of retail goods from one or more specified retailers, the user can get an advantage in the game.

20. The method of claim 16, wherein if a user is eliminated from the game, that user's avatar can begin to melt, fade away or burn but if the user orders a specified amount of retail goods from one or more specified retailers within a specified amount of time the user can get a new life (and the user's avatar would be made whole again).

21. The method of claim 16, wherein users can have the ability to make bets with virtual or actual currency to determine the “pot” of currency that can be won for each game.

22. The method of claim 12, comprising a ranking system for the users based on points accumulated, games played and win-loss record.
